(19) United States
(12) Patent Application Publication
(10) Pub. No.: US 2026/0244909 A1
(43) Pub. Date: Aug. 20, 2026

(54) NEURAL NETWORK CIRCUIT DEVICE

(71) Applicant: NTT, Inc., Tokyo (JP)

(72) Inventor: Takao YAMASHITA, Musashino-shi, Tokyo (JP)

(21) Appl. No.: 18/878,973

(22) PCT Filed: Jun. 23, 2023
(86) PCT No.: PCT/JP2023/023437

§ 371 Date: Dec. 26, 2024

(30) Foreign Application Priority Data
Jun. 27, 2022 (WO) PCT/JP2022/025634

(51) Int. Cl. G06N 3/063

(52) U.S. Cl. CPC G06N 3/063

(57) ABSTRACT

A logical conjunction operation circuit that calculates a logical product between a vector of a learning phase and a vector of an inference phase, a first counter that counts the number of inputs of input vectors having a value of 1 at the time of the inference phase, a second counter that counts the number of inputs of logical product vectors having a value of 1 obtained by a logical conjunction operation by the logical conjunction operation circuit, a third counter that counts the number of inputs of vectors having a value of 1 at the time of the learning phase, an adder circuit that adds an output of the first counter and an output of the third counter, a shift register that shifts a result of the second counter to a high-order side by 1 bit, and a divider circuit that divides an output vector of the shift register by an output vector of the adder circuit are included.

### CROSS-REFERENCE TO RELATED APPLICATIONS

This is a National Stage Application of PCT Application No. PCT/JP2023/023437, filed on Jun. 23, 2023. The disclosure of the prior application is considered part of the disclosure of this application, and is incorporated in its entirety into this application.

### BACKGROUND

### Technical Field

The present invention relates to a neural network circuit device.

### Background Art

In recent years, artificial intelligence technology using an artificial neural network has developed, and various industrial applications have progressed. Such a neural network is characterized by using a network in which perceptrons obtained by modeling a nerve cell are connected. In a neural network, calculation is performed based on an input to the entire network, and a calculation result is output.

As a perceptron used in an artificial neural network, a perceptron obtained by developing early nerve cell modeling is used.

FIG. 32 is a diagram illustrating an operation of a perceptron 200 including a variable constant input.

As illustrated in FIG. 32, b, x₁, x₂, . . . x_{N} are input to the perceptron 200 as N+1 input values. Among them, N external inputs are input to the entire neural network, and an input value xᵢ is input to an input i. b is a constant value held inside the neural network. In addition, one output y is output from the perceptron as the output of the neural network. A value wᵢ called a weight is assigned to the input i (i=1, 2, . . . N) (hereinafter, it is referred to as a synaptic weight). At this time, the output y is represented by Formula (1).

$$\begin{matrix}[ Formula 1 ] & \\ y = f ( {\sum }_{i = 1}^{N} {w}_{i} {x}_{i} + b ) & ( 1 )\end{matrix}$$

Here, f(·) represents an activation function. As the activation function, a nonlinear function such as a sigmoid function or a tanh function, a rectified linear unit function (ReLU), or the like is often used.

In Formula (1), in order to eliminate the difference in notation between wᵢxᵢ and b and make the formula easy to see, a circuit as illustrated in FIG. 13 in which a constant input is set to 1 and a synaptic weight w₀ for the constant input is set to b and Formula (2) described below are often used. FIG. 33 is a diagram illustrating an operation of the perceptron 200 in which expression of input/synaptic weight is generalized.

$$\begin{matrix}[ Formula 2 ] & \\ y = f ( {\sum }_{i = 0}^{N} {w}_{i} {x}_{i} ) & ( 2 )\end{matrix}$$

As expressed in Formula (2), the value passed to the activation function is calculated on the basis of the value of the input, and the value to be output is calculated by the activation function. In the following description, a value passed to the activation function is referred to as an activation degree. When the activation function is represented by f(a), a is the activation degree. Normally, when machine learning is performed using an artificial neural network, a network in which one or more perceptrons 200 are hierarchically connected as illustrated in FIG. 34 is used. FIG. 34 is a diagram illustrating a multilayered artificial neural network.

The artificial neural network has a plurality of combinations of input values xᵢ (i=1, 2, . . . , N). When one combination is represented by j and each of the input values xᵢ (i=1, 2, . . . , N) of the combination j is considered as a component of a vector, a vector including xᵢ (i=1, 2, . . . , N) is represented as xⱼ. Here, a component of xⱼ is represented as xⱼ=(xⱼ₁, xⱼ₂, . . . , x_{jN}) T (T included in (xⱼ=(xⱼ₁, xⱼ₂, . . . , x_{jN})^{T} means conversion of the vector into a column vector).

Next, a plurality of those in which a target value lⱼ is assigned is prepared with respect to each xⱼ, and the value of wᵢ is determined using it as learning data. This value is determined so as to minimize an error with respect to the entire learning data by using a difference between a value calculated by the neural network and the target value as an error.

In such a type of machine learning method using an artificial neural network, learning data itself is not stored in the neural network. On the other hand, among machine learning methods, there is a method called a k-nearest neighbor algorithm in which learning data is stored, similarity between an input and a storage pattern is calculated, and a label is output using k pieces of memory having high similarity. It is known that the k-nearest neighbor algorithm can perform relatively stable learning even in a case where the learning data is small, and there is an advantage depending on the application.

In addition, as a function of the brain, as described in Non Patent Literature 4, when there is a plurality of inputs from the outside, even in a case where a completely matched input pattern is not stored with respect to an input pattern that is a combination of the inputs, it is considered that there is a function of pattern complementation that completely recall a close memory already fixed in the brain. Searching for a memory close to an input pattern from the outside is one of the functions of human intelligence, and calculating similarity between the input and the storage pattern is basic information for searching for the most similar memory, and therefore, as an elemental technology of a method for achieving pattern complementation, a technology for calculating similarity between the input and the storage pattern is important.

As described above, it is an elemental technology for artificially achieving intelligent functions such as machine learning and the recollection of similar memories, which are considered to be included in a human by a neural network.

In neurons and neural networks on which perceptrons and artificial neural networks are based, there are Associative Networks described in Non Patent Literature 1, Non Patent Literature 2, and Non Patent Literature 3 as techniques for learning information input in the past, storing the information, comparing the stored information with current input, and determining similarity. Examples of neurons used in the Associative Network and the Associative Network are illustrated in FIGS. 35 and 36, respectively.

FIG. 35 is a diagram illustrating an example of a simple Associative Network. In FIG. 35, a neuron 300 is represented by a combination of an arrow and a black triangle. The upper side of this triangle (the side without the arrow portion) corresponds to the input portion of this neuron, and the lower side of the triangle (the side with the arrow portion) corresponds to the output portion of this neuron.

Now, it is assumed that there is a neuron 300 that changes to a firing state (representing a state in which the membrane potential of a nerve cell rises and exceeds a threshold) when a certain input A is added in the neural network. Then, when input B is repeatedly added at the same time when the input A is added, a phenomenon in which the neuron 300 changes to the firing state only by the input B occurs. This is a phenomenon described by the Hebb's rule that the connection of the synapse formed between the input B and the neuron 300 is strengthened by simultaneously firing the neuron generating the input B and the neuron 300. At this time, a phenomenon that the neuron 300 enters the firing state only by the input B is referred to as classical conditioning, and the input A and the input B are referred to as an unconditioned stimulus and a conditioned stimulus, respectively.

FIG. 36 is a diagram illustrating an example of an Associative Network including a plurality of unconditioned stimuli.

FIG. 36 illustrates a case where different unconditioned stimuli P, Q, and R are associated with one conditioned stimulus C by classical conditioning. The unconditioned stimulus P and the conditioned stimulus C are input to a neuron 301. The unconditioned stimulus Q and the conditioned stimulus C are input to a neuron 302. The unconditioned stimulus R and the conditioned stimulus C are input to a neuron 303.

Next, a technique for determining similarity by the Associative Network will be described.

FIG. 37 is a diagram for describing the neuron 300 as a component of the Associative Network regarding a technique for determining similarity by the Associative Network. FIG. 37 is setting of synaptic weights in a simple Associative Network.

Four input values x₁, x₂, x₃, and x₄ are input to the neuron 300 in FIG. 37. Here, an input value xⱼ is input to an input i. These input values are one of binary values of 0 and 1. This is related to the state of a preceding neuron generating individual inputs, and 0 corresponds to the non-firing state of the preceding neuron (a state in which the membrane potential of a nerve cell does not reach a threshold membrane potential state), and 1 corresponds to the firing state of the preceding neuron. This corresponds to that a neurotransmitter does not reach the connected neuron in the non-firing state, and that a neurotransmitter reaches in the firing state. Since a combination of input values to a neuron can be regarded as a vector having each as a component, a vector having x₁, x₂, x₃, and x₄ as components is represented as x, and x=(x₁, x₂₁ x₃, x₄)^{T}. Hereinafter, x is referred to as an input vector.

It is assumed that a synaptic weight is assigned to a synapse whose input is a portion connected to a neuron, and w₁, w₂, w₃, and w₄ are assigned to inputs 1, 2, 3, and 4, respectively. Since this combination of synaptic weights can also be regarded as a vector, a synaptic weight vector w is expressed as w=(w₁, w₂, w₃, w₄)^{T} by using the same notation as the input.

FIGS. 38A to 38F are diagrams for describing similarity calculation in the conventional art.

FIG. 38A illustrates a state at the time of learning of the Associative Network. Six inputs are connected to the neuron 300 in FIG. 38A. In FIG. 38A, an input vector x₁ is set as x₁=(1, 0, 0, 1, 0, 1) “. With this learning, a synaptic weight vector is set as illustrated in FIG. 38B. This indicates that when the neuron 300 illustrated in FIG. 38A is in the firing state, the input vector x₁=(1, 0, 0, 1, 0, 1)” is added, and the corresponding synaptic weight is set to 1 on the basis of the Hebb's rule for the input having a value of 1 among the components of the input vector. That is, w=x₁.

As an example of the first similarity determination, as illustrated in FIG. 38C, it is assumed that x₁=(1, 0, 0, 1, 0, 1)^{T} is input as an input vector x₁. That is, it is assumed that the same input vector as that at the time of learning is also added at the time of similarity determination. In the Associative Network, at this time, similarity between x₁ and the input x₁ at the time of learning is calculated as an inner product of both vectors. That is, the inner product is x₁·x₁. Since w=x₁, the inner product can be rewritten as w·x₁. The degree of similarity (hereinafter, referred to as an inner product similarity) calculated in this manner is 3. At this time, the activation degree of the neuron in FIG. 43C, that is, the value passed to the activation function of the neuron to determine the output is considered to be equal to the inner product similarity. If the neuron 300 in FIG. 38C has a step function with a threshold of 3 as an activation function, this neuron 300 outputs 1.

As an example of the second similarity determination, as illustrated in FIG. 38D, it is assumed that x₂=(1, 0, 0, 1, 1, 0)^{T} is input as an input vector x₂. The inner product similarity at this time is 2, indicating that the number of inputs having a value of 1 is one less than the input vector x₁ at the time of learning. When the neuron 300 in FIG. 43D has the same activation function as that when the input vector x₂ described above is input, the inner product similarity does not reach a threshold of 3, and thus 0 is output.

As an example of the third similarity determination, as illustrated in FIG. 38E, it is assumed that x₃=(1, 0, 0, 1, 0, 0)^{T} is input as an input vector x₃. Also at this time, the inner product similarity is 2, indicating that the number of inputs having a value of 1 is one less than the input vector x₁ at the time of learning. Also in this case, 0 is output as in FIG. 43D.

Here, looking at the difference between the input vectors x₂ and x₃, in x₂, there is one input in which the input at the time of learning is 0 and the input at the time of similarity determination is 1, and there is one input in which the input at the time of learning is 1 and the input at the time of similarity determination is 0. That is, there are two inputs resulting in the difference. On the other hand, in X₃, there is only one input in which the input at the time of learning is 1 and the input at the time of similarity determination is 0. That is, there is only one input resulting in the difference. Therefore, x₃ is practically closer to x₁, but the inner product similarity has the same value.

As an example of the fourth similarity determination, as illustrated in FIG. 38F, it is assumed that x₄=(1, 1, 1, 1, 0, 1)^{T} is input as an input vector x₄. The inner product similarity at this time is 3, which is the same value as the first similarity determination example in which the input vector x₁ at the time of learning is input as it is. However, while x₁ is exactly the same as x₁, in x₄, the same result as in the case of x₁ is obtained although there are two inputs in which the input at the time of learning is 0 and the input at the time of similarity determination is 1.

### RELATED ART

### Non Patent Literature

Non Patent Literature 1: B. L. McNaughton, R. G. M. Morris, “Hippocampal synaptic enhancement and information storage within a distributed memory system”, Trends in Neuroscience, volume 10, Issue 10, pp. 408-415, 1987.
Non Patent Literature 2: Thomas Trappenberg, “Fundamentals of Computational Neuroscience”, Oxford University Press, 2010.
Non Patent Literature 3: Edmund T. Roll, “Cerebral Cortex: Principles of Operation”, Oxford University Press, 2016.
Non Patent Literature 4: Eric R. Kandel, James H. Schwartz, Thomas M. Jessell, Steven A. Siegelbaum, A. J. Hudspeth, “PRINCIPLES OF NEURAL SCIENCE: Fifth Edition”, McGraw-Hill Education, 2012.
Non Patent Literature 5: David J. Heeger, “Normalization of cell responses in cat striate cortex”, Visual Neuroscience, vol. 9, pp. 181-197, 1992.
Non Patent Literature 6: T. Tanimoto, “An elementary mathematical theory of classification and prediction.”, Technical report, International Business Machines Corporation, New York, 1958.
Non Patent Literature 7: P. Jaccard, “The distribution of the flora in the alpine zone”, Phytologist, 1912; 11 (2): 37-50. https://doi.org/10.1111/j.1469-8137.1912.tb05611.x.
Non Patent Literature 8: G. A. Carpenter, S. Grossberg, N. Markuzon, J. H. Reynolds, D. B. Rosen, “Fuzzy ARTMAP: A Neural Network Architecture for Incremental Supervised Learning of Analog Multidimensional Maps”, IEEE Transactions of Neural Network, Vol. 3, No. 5, pp. 698-713, 1992.
https://ieeexplore.ieee.org/stamp/stamp.jsp?tp=&arnumber=15
Non Patent Literature 9: L. Zadeh, “Fuzzy sets”, Information and Control, Vol. 8, No. 3, pp. 338-353, 1965.

### SUMMARY OF INVENTION

### Technical Problem

In the Associative Network, an input of a neural network is used as a vector (input vector), and an inner product of an input vector at the time of learning and an input vector for determining similarity is calculated to determine similarity. Actually, even if there is a difference in distance between two input vectors for determining similarity with respect to the input vector at the time of learning, the inner product similarity may have the same value.

For example, as in the third similarity determination example illustrated in FIG. 38E, x₃ is practically closer to x₁, but the inner product similarity has the same value, or as in the fourth similarity determination example illustrated in FIG. 38F, in x₄, the same result as in the case of x₁ may be obtained although there are two inputs in which the input at the time of learning is 0 and the input at the time of similarity determination is 1.

As described above, in the similarity calculation in the conventional art, there is a problem that the difference between the input vector at the time of learning and the input vector at the time of similarity determination cannot be accurately determined for the inner product similarity.

The present invention has been made in view of such circumstances, and an object is to achieve a circuit device that accurately determines a difference between an input vector at the time of learning and an input vector at the time of similarity determination when determining the inner product similarity.

### Solution to Problem

In order to solve the above problem, a neural network circuit device that calculates a degree of similarity between an input of a learning phase and an input of an inference phase using a perceptron obtained by modeling a nerve cell is a neural network circuit device including: a logical conjunction operation circuit that calculates a logical product between a vector of the learning phase and a vector of the inference phase; a first counter that counts a number of inputs of input vectors having a value of 1 at a time of the inference phase; a second counter that counts a number of inputs of logical product vectors having a value of 1 obtained by a logical conjunction operation by the logical conjunction operation circuit; a third counter that counts a number of inputs of vectors having a value of 1 at a time of the learning phase; an adder circuit that adds an output of the first counter and an output of the third counter; a shift register that shifts a result of the second counter to a high-order side by 1 bit; and a divider circuit that divides an output vector of the shift register by an output vector of the adder circuit.

### Advantageous Effects of Invention

According to the present invention, it is possible to achieve a circuit device that accurately determines a difference between an input vector at the time of learning and an input vector at the time of similarity determination when determining the inner product similarity.

### BRIEF DESCRIPTION OF DRAWINGS

FIG. 1 illustrates an example of a neural circuit that performs divisive normalization operation of a divisive normalization similarity determination method according to a first embodiment of the present invention.

FIG. 2 is a diagram illustrating an example of a circuit that performs a divisive normalization similarity determination method of the divisive normalization similarity determination method according to the first embodiment of the present invention.

FIG. 3 is a diagram illustrating setting of synaptic weights in the divisive normalization similarity determination method according to the first embodiment of the present invention.

FIG. 4 is a diagram illustrating a similarity determination phase in the divisive normalization similarity determination method according to the first embodiment of the present invention.

FIG. 5 is a diagram illustrating a neural network circuit device in a case where an activation function is a “step function” in a divisive normalization similarity calculation method according to the first embodiment of the present invention.

FIG. 6 is a diagram for describing a method for implementing Bitwise-AND of a Bitwise-AND circuit of the neural network circuit device according to the first embodiment of the present invention.

FIG. 7 is a diagram for describing a method for implementing a T counter in the neural network circuit device according to the first embodiment of the present invention.

FIG. 8 is a diagram illustrating a neural network circuit device in a case where an activation function is a “linear function” in a divisive normalization similarity calculation method according to a second embodiment of the present invention.

FIG. 9 is a diagram illustrating an example of a memory configuration for storing a reciprocal of a divisor by a method for storing in memory a reciprocal of a denominator of Formula (6) in a neural network circuit device according to a third embodiment of the present invention.

FIG. 10 is a circuit diagram illustrating an example of a configuration of a divider circuit by the method for storing in the memory the reciprocal of the denominator of Formula (6) in the neural network circuit device according to the third embodiment of the present invention.

FIG. 11 is a diagram illustrating an activation degree (N=100) of a perceptron that performs output of a diffusive information network when only a divisive normalization similarity calculation method and a diffusive learning network of a neural network circuit device according to a fourth embodiment of the present invention are used.

FIG. 12 is a diagram illustrating an activation degree (N=1000) of the perceptron that performs output of the diffusive information network when only the divisive normalization similarity calculation method and the diffusive learning network of the neural network circuit device according to the fourth embodiment of the present invention are used.

FIG. 13 is a diagram illustrating an activation degree (output change when the number of inputs in which input value is 1 at the time of learning and 0 at the time of similarity determination is changed) of the perceptron that performs output of the diffusive information network when the divisive normalization similarity calculation method, the diffusive learning network, and a noise addition sensitivity characteristic improvement method of the neural network circuit device according to the fourth embodiment of the present invention are used.

FIG. 14 is a diagram illustrating an activation degree (output change when the number of inputs in which input value is 0 at the time of learning and 1 at the time of similarity determination is changed) of the perceptron that performs output of the diffusive information network when the divisive normalization similarity calculation method, the diffusive learning network, and the noise addition sensitivity characteristic improvement method of the neural network circuit device according to the fourth embodiment of the present invention are used.

FIG. 15 is a diagram comparing an activation degree (output change when the number of inputs in which input value is 1 at the time of learning and 0 at the time of similarity determination is changed) of the perceptron that performs output of the diffusive information network and raised Tanimoto similarity when the divisive normalization similarity calculation method, the diffusive learning network, and the noise addition sensitivity characteristic improvement method of the neural network circuit device according to the fourth embodiment of the present invention are used.

FIG. 16 is a diagram comparing an activation degree (output change when the number of inputs in which input value is 0 at the time of learning and 1 at the time of similarity determination is changed) of the perceptron that performs output of the diffusive information network and raised Tanimoto similarity when the divisive normalization similarity calculation method, the diffusive learning network, and the noise addition sensitivity characteristic improvement method of the neural network circuit device according to the fourth embodiment of the present invention are used.

FIG. 17 is a diagram illustrating an output (when the number of inputs in which “input value is 1 at the time of learning and 0 at the time of similarity determination” is changed) of the perceptron when a sigmoid function is used as an activation function in divisive normalization similarity calculation of the neural network circuit device according to the fourth embodiment of the present invention.

FIG. 18 is a diagram illustrating an output (when the number of inputs in which “input value is 0 at the time of learning and 1 at the time of similarity determination” is changed) of the perceptron when a sigmoid function is used as an activation function in divisive normalization similarity calculation of the neural network circuit device according to the fourth embodiment of the present invention.

FIG. 19 is a diagram illustrating an expected value of an output (when the number of inputs in which “input value is 1 at the time of learning and 0 at the time of similarity determination” is changed) of the perceptron when the noise addition sensitivity characteristic improvement method of the neural network circuit device according to the fourth embodiment of the present invention is used.

FIG. 20 is a diagram illustrating an expected value of an output (when the number of inputs in which “input value is 0 at the time of learning and 1 at the time of similarity determination” is changed) of the perceptron when the noise addition sensitivity characteristic improvement method of the neural network circuit device according to the fourth embodiment of the present invention is used.

FIG. 21 is a diagram illustrating a neural network circuit device in a case where the divisive normalization similarity calculation and the noise addition sensitivity characteristic improvement method are combined in a case where an activation function of the neural network circuit device according to the fourth embodiment of the present invention is a step function for which any threshold can be set.

FIG. 22 is a parallel circuit in which a plurality of neural network circuit devices in which the divisive normalization similarity calculation and the noise addition sensitivity characteristic improvement method of the neural network circuit device according to the fourth embodiment of the present invention are combined are connected.

FIG. 23 is a diagram illustrating a neural network circuit device in a case where the divisive normalization similarity calculation and the noise addition sensitivity characteristic improvement method are combined in a case where an activation function of the neural network circuit device according to the fourth embodiment of the present invention is a linear function for which any threshold can be set.

FIG. 24 is a parallel circuit in which a plurality of neural network circuit devices in which the divisive normalization similarity calculation and the noise addition sensitivity characteristic improvement method of the neural network circuit device according to the fourth embodiment of the present invention are combined are connected.

FIG. 25 is a diagram illustrating a comparison between an expected value of an output (output change when the number of inputs in which input value is 1 at the time of learning and 0 at the time of similarity determination is changed) of the perceptron and raised Tanimoto similarity when the divisive normalization similarity calculation method and the noise addition sensitivity characteristic improvement method of the neural network circuit device according to the fourth embodiment of the present invention are used.

FIG. 26 is a diagram illustrating a comparison between an expected value of an output (output change when the number of inputs in which input value is 0 at the time of learning and 1 at the time of similarity determination is changed) of the perceptron and raised Tanimoto similarity when the divisive normalization similarity calculation method and the noise addition sensitivity characteristic improvement method of the neural network circuit device according to the fourth embodiment of the present invention are used.

FIG. 27 is a diagram for describing an example of similarity by a divisive normalization similarity calculation method using Fuzzy logic of a neural network circuit device according to a fifth embodiment of the present invention.

FIG. 28 is a diagram illustrating a neural network circuit device that achieves divisive normalization similarity calculation using Fuzzy logic in a case where an activation function according to the fifth embodiment of the present invention is a step function for which any threshold can be set.

FIG. 29 is a diagram illustrating a neural network circuit device that achieves divisive normalization similarity calculation using Fuzzy logic in a case where an activation function according to the fifth embodiment of the present invention is a linear function for which any threshold can be set.

FIG. 30 is a diagram illustrating a neural network circuit device in a case where the divisive normalization similarity calculation using Fuzzy logic and the noise addition sensitivity characteristic improvement method are combined in a case where an activation function according to the fifth embodiment of the present invention is a step function for which any threshold can be set.

FIG. 31 is a diagram illustrating a neural network circuit device in a case where the divisive normalization similarity calculation using Fuzzy logic and the noise addition sensitivity characteristic improvement method are combined in a case where an activation function according to the fifth embodiment of the present invention is a step function for which any threshold can be set.

FIG. 32 is a diagram illustrating an operation of a perceptron including a variable constant input.

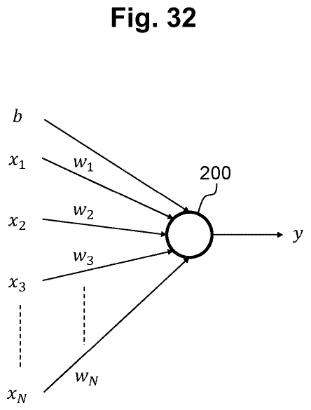

FIG. 33 is a diagram illustrating an operation of a perceptron in which expression of input/synaptic weight is generalized.

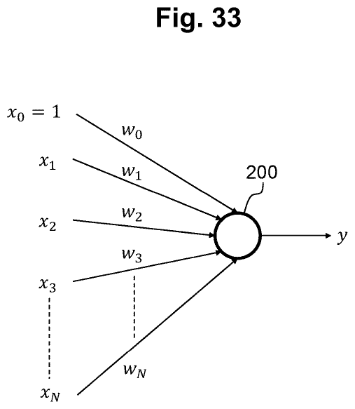

FIG. 34 is a diagram illustrating a multilayered artificial neural network.

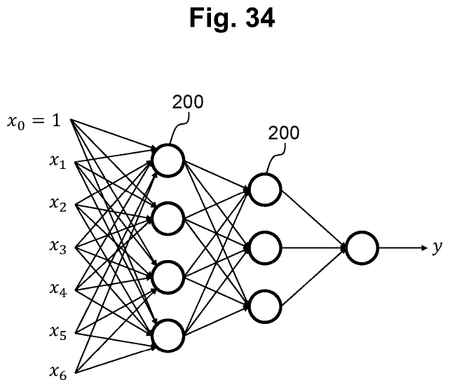

FIG. 35 is a diagram illustrating an example of a simple Associative Network.

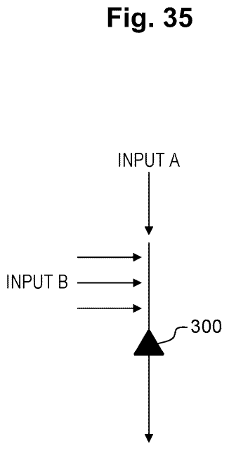

FIG. 36 is a diagram illustrating an example of an Associative Network including a plurality of unconditioned stimuli.

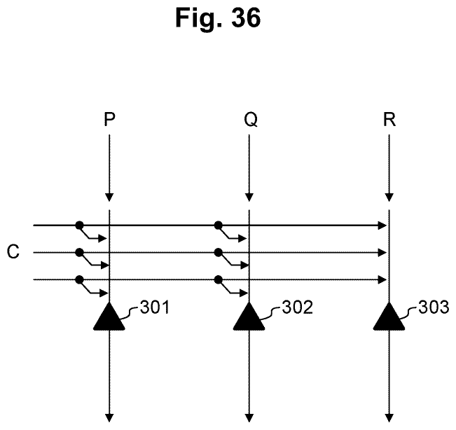

FIG. 37 is a diagram for describing a neuron as a component of the Associative Network regarding a technique for determining similarity by the Associative Network.

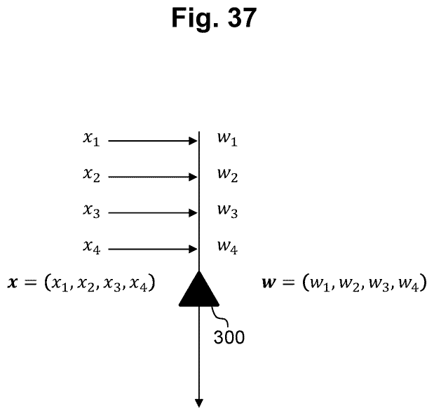

FIG. 38A is a diagram for describing similarity calculation in the conventional art.

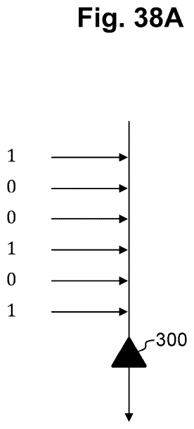

FIG. 38B is a diagram for describing similarity calculation in the conventional art.

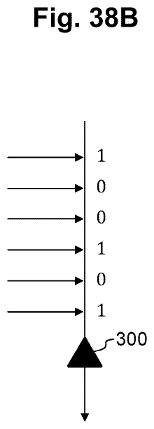

FIG. 38C is a diagram for describing similarity calculation in the conventional art.

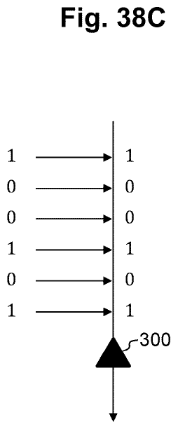

FIG. 38D is a diagram for describing similarity calculation in the conventional art.

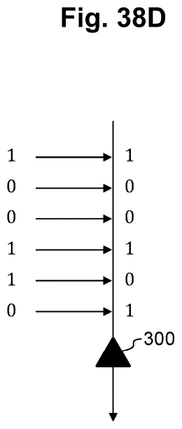

FIG. 38E is a diagram for describing similarity calculation in the conventional art.

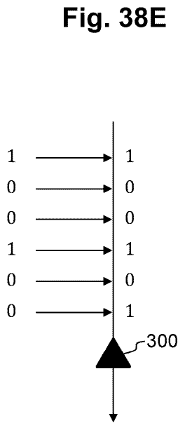

FIG. 38F is a diagram for describing similarity calculation in the conventional art.

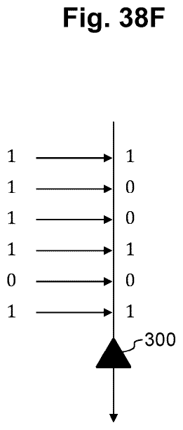

### DESCRIPTION OF EMBODIMENTS

Hereinafter, a neural network circuit device and the like according to a mode for carrying out the present invention (hereinafter, referred to as “the present embodiment”) will be described with reference to the drawings.

### First Embodiment

The present invention is achieved by combining [divisive normalization similarity determination method] and [diffusive learning network method].

### [Divisive Normalization Similarity Determination Method]

First, a divisive normalization similarity determination method (similarity determination method) will be described.

In the similarity determination by the Associative Network described as the existing technology, the similarity is calculated by the inner product of the input vector at the time of learning and the input vector at the time of similarity determination. Thus, each neuron has a capability of calculating (that is, as an operation, multiplication), for each input, the product of the input value and the value of the synaptic weight and adding the value of the product for all inputs. In general, assuming that the input value can take any real number value, since the input value and the value of the synaptic weight can also be a negative value, in practice, it has a capability of multiplication, addition, and subtraction.

On the other hand, in the divisive normalization similarity determination method, in addition to multiplication, addition, and subtraction, an operation caused by a phenomenon called a shunt effect (Non Patent Literature 4) of nerve cells (neurons) is incorporated into the model of perceptron. The shunt effect is caused by inhibitory synapses formed in the nerve cell near the cell body. The shunt effect is the effect of dividing an overall added signal transmitted to the neuron by a signal transmitted via an inhibitory synapse formed near the cell body. The division caused by the shunt effect is also used in a model called divisive normalization for describing visual sensitivity adjustment as described in Non Patent Literature 5.

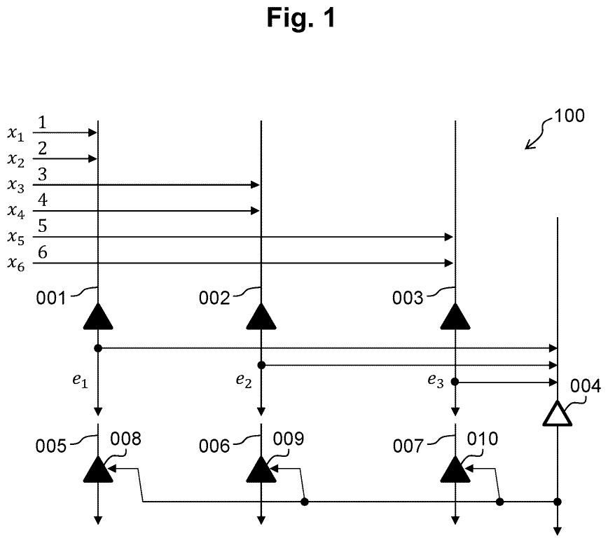

FIG. 1 is a diagram illustrating an example of a divisive normalization similarity calculation unit for divisive normalization, and illustrates an example of a neural circuit that performs a divisive normalization operation. In FIG. 1, neurons 001, 002, and 003 including black triangles form excitatory synapses with respect to 005, 006, and 007, respectively, and a neuron 004 including a white triangle (Δ) forms inhibitory synapses 008, 009, and 010. Here, the excitatory synapse is a synapse having an action of directing the activation state of the neuron on the side receiving the synapse to firing. In addition, the inhibitory synapse is, conversely, a synapse having an action of directing the activation state to resting. In FIG. 1, the inhibitory synapses 008, 009, and 010 formed by the neuron 004 are connected to the black triangles, which indicates that the inhibitory synapses 008, 009, and 010 exhibit the shunt effect.

The neurons 001, 002, and 003 in FIG. 1 receive inputs 1 and 2, 3 and 4, and 5 and 6, respectively, and input values x₁ and x₂, x₃ and x₄, and x₅ and x₆ are input, respectively. It is assumed that output values of the neurons 001, 002, and 003 become e₁, e₂, and e₃ by these inputs, respectively. The output values e₁, e₂, and e₃ are sent to neurons 005, 006, and 007, respectively. Here, it is assumed that these output values are directly transmitted to the neurons 005, 006, and 007, and become the respective activation degrees. In addition, it is assumed that the neuron 004 receives e₁, e₂, and e₃ as they are and sets the activation degree to a value of Σ³ⱼ₌1eⱼ. Then, it is assumed that the activation degree of the neuron 004 is output as it is and sent to the neurons 005, 006, and 007 to cause the shunt effect at the synapses 008, 009, and 010. At this time, the effect of divisive normalization is expressed by the following formula, and the neurons 005, 006, and 007 have the activation degree expressed by Formula (3). Here, k is 1, 2, or 3.

$$\begin{matrix}[ Formula 3 ] & \\ \frac{{e}_{k}}{C + {\sum }_{j = 1}^{3} {e}_{j}} & ( 3 )\end{matrix}$$

At this time, the activation degrees of the neurons 005, 006, and 007 are values when numerators are set to e₁, e₂, and e₃, respectively, in Formula (3) described above. In this manner, in divisive normalization, the activation degree of a certain neuron is divided by the sum of the outputs of a plurality of neurons (in the example of FIG. 1, the neurons 001, 002, and 003) called a neuronal pool. This effect describes the visual sensitivity adjustment. At this time, in a divisive normalization model, a change due to learning of the synaptic weight is not considered, and further, the value of C is experimentally determined so that the current input to vision is not saturated, and thus, a clear determination method according to the input at the time of learning or the like is not defined.

[Divisive normalization similarity determination method] of the present invention is achieved by (A) a method of determining a synaptic weight, (B) a method of determining a constant C of divisive normalization, and (C) a method of determining a perceptron set (hereinafter, referred to as a perceptron pool) corresponding to a neuronal pool in divisive normalization described below.

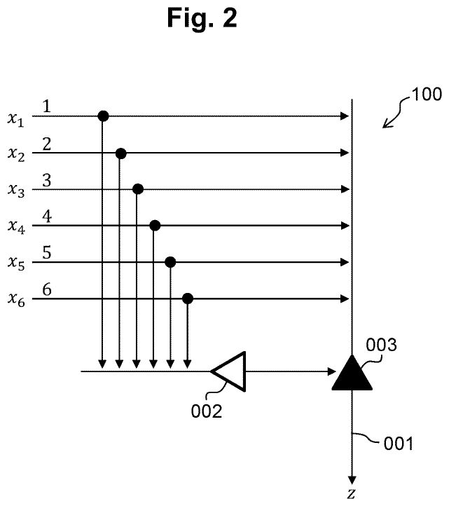

FIG. 2 is a diagram illustrating an example of a divisive normalization similarity calculation unit (similarity calculation unit) that performs the divisive normalization similarity determination method, and illustrates a learning phase in the example of the divisive normalization similarity determination method.

Hereinafter, a module that executes the processing of the divisive normalization similarity determination method is referred to as a divisive normalization similarity calculation unit 100 (similarity calculation unit).

The input values x₁, x₂, x₃, x₄, x₅, and x₆ to the inputs 1, 2, 3, 4, 5, and 6 illustrated in FIG. 2 represent input values to the divisive normalization similarity calculation unit 100. These are equally input to perceptrons 001 and 002. As described above, in the divisive normalization similarity determination method, only all the inputs to the divisive normalization similarity calculation unit are used as the perceptron pool in (C) divisive normalization. Each input takes two types of values when a preceding perceptron is in the resting state and in the firing state, and these are represented by 0 and 1, respectively, in the present specification. That is, xⱼ∈{0,1} (i=1, 2, 3, 4, 5, 6) holds.

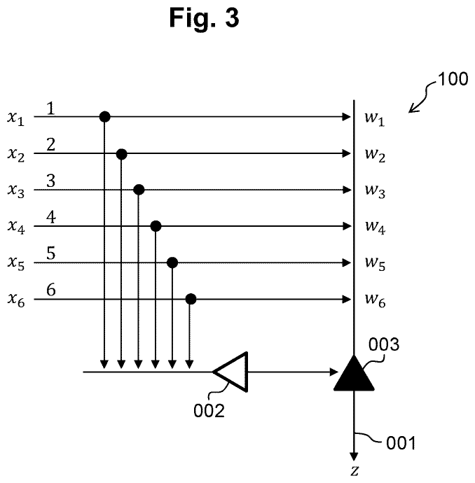

FIG. 3 is a diagram illustrating setting of synaptic weights in the divisive normalization similarity determination method. FIG. 3 illustrates that, as a result of the learning phase of FIG. 2, the synaptic weights formed in the perceptron 001 by the input values x₁, x₂, x₃, x₄, x₅, and x₆ are w₁, w₂, w₃, w₄, w₅, and w₆.

In (A) a method of determining a synaptic weight of the divisive normalization similarity determination method, the synaptic weight is set as wᵢ=xᵢ. That is, the weight of the synapse that has received the input signal corresponding to the firing state in the learning phase is 1, and the weight of the synapse that has received the input signal corresponding to the resting state is 0.

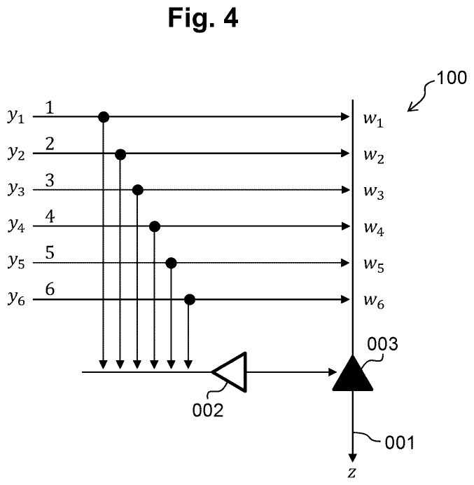

FIG. 4 is a diagram illustrating a similarity determination phase in the divisive normalization similarity determination method. FIG. 4 illustrates a similarity determination phase when the input values y₁, y₂, y₃, y₄, y₅, and y arrive. At this time, the input to the perceptron 001 is calculated by Σ⁶ⱼ₌₁yⱼ·wⱼ. On the other hand, there is no change in the synaptic weight, and Σ⁶ⱼ₌₁yⱼ is input to a perceptron 002. The output of the perceptron 002 generates the shunt effect in the perceptron 001 through a synapse 003 formed with respect to the perceptron 001, and calculates the following operation.

$$\begin{matrix}[ Formula 4 ] & \\ \frac{2 {\sum }_{j = 1}^{6} {y}_{j} \cdot {w}_{j}}{C + {\sum }_{j = 1}^{6} {y}_{j}} & ( 4 )\end{matrix}$$

Further, as (B) a method of determining a constant C of divisive normalization, the constant C is set to a value calculated as described below in the learning phase.

$$\begin{matrix}[ Formula 5 ] & \\ C = {‖ x ‖}^{2} & ( 5 )\end{matrix}$$

Here, x=(x₁, x₂, x₃, x₄, x₅, x₆)^{T}, and ∥x∥ represents the norm of a vector x. When Formula (5) is substituted into Formula (4), Formula (4) is converted into Formula (6) described below.

$$\begin{matrix}[ Formula 6 ] & \\ \frac{2 {\sum }_{j = 1}^{6} {y}_{j} \cdot {w}_{j}}{{‖ x ‖}^{2} + {\sum }_{j = 1}^{6} {y}_{j}} = \frac{2 ( y \cdot w )}{{‖ w ‖}^{2} + {‖ y ‖}^{2}} & ( 6 )\end{matrix}$$

where y=(y₁, y₂, y₃, y₄, y₅, y₆)^{T} and w=(w₁, w₂, w₃₁ w₄, w₅, w₆)^{T}.

Formula (6) includes the square of the norm and the inner product of the two vectors as vector operations. In general, when there are a vector v=(v₁, v₂, . . . , v_{N})^{T} and a vector u=(u₁, u₂, . . . , u_{N})^{T}, ∥u∥²=u₁²+u₂²+ . . . +u_{N}² and u·v=u₁v₁+u₂v₂+ . . . +u_{N}v_{N}.

Now, if uᵢ∈{0, 1} and vᵢ∈{0,1}, ∥u∥²=u₁²+u₂²+ . . . +u_{N}²=u₁+u₂+ . . . +u_{N}, and uᵥ=u₁v₁+u₂v₂+ . . . +u_{N}v_{N}=Σ^{N}ᵢ=₁uᵢvᵢ=Σ^{N}ᵢ₌₁ (uᵢANDvᵢ) can also be calculated. uᵢANDvᵢ represents a logical conjunction operation of uᵢ and vᵢ.

Here, n₁₁, n₁₀, n₀₁, and n₀₀ are the number of inputs satisfying xᵢ=1 and yᵢ=1, the number of inputs satisfying xᵢ=1 and yᵢ=0, the number of inputs satisfying xᵢ=0 and yᵢ=1, and the number of inputs satisfying xᵢ=0 and yᵢ=0, respectively. In addition, N=n₁₁+n₁₀+n₀₁+n₀₀ represents the entire number of inputs and is therefore constant. Formula (6) descried above can be modified as described below.

$$\begin{matrix}[ Formula 7 ] & \\ \frac{2 ( y \cdot w )}{{‖ w ‖}^{2} + {‖ y ‖}^{2}} = \frac{2 {n}_{11}}{{n}_{11} + {n}_{10} + {n}_{11} + {n}_{01}} = \frac{2 {n}_{11}}{2 {n}_{11} + {n}_{10} + {n}_{01}} & ( 7 )\end{matrix}$$

In the calculation of Formula (7), when the denominator is 0, since all of n₁₁, n₁₀, and n₀₁ are 0, the numerator is also nu, and the value thereof is also 0. The calculation result of Formula (7) in this case is calculated as 0 because there is no similarity between the two vectors.

Now, when the same input is obtained in the learning phase and the similarity determination phase, since n₁₀=n₀₁=0, Formula (8) is obtained.

$$\begin{matrix}[ Formula 8 ] & \\ \frac{2 {n}_{11}}{2 {n}_{11} + {n}_{10} + {n}_{01}} = \frac{2 {n}_{11}}{2 {n}_{11}} = 1 & ( 8 )\end{matrix}$$

Next, a case where inputs are different between the learning phase and the similarity determination phase will be considered. N_{f}=n₁₁+n₁₀ is the number in which 1 is input at the time of learning and is constant in the similarity determination phase after the learning phase. Using this N_{f}, Formula (7) can be modified as described below.

$$\begin{matrix}[ Formula 9 ] & \\ \frac{2 {n}_{11}}{2 {n}_{11} + {n}_{10} + {n}_{01}} = \frac{2 ( {N}_{f} - {n}_{10} )}{2 {N}_{f} - {n}_{10} + {n}_{01}} & ( 9 )\end{matrix}$$

From Formula (9), it can be seen that the value calculated by Formula (9) changes only by n₁₀ and n₀₁. From here, how the value of Formula (9) changes due to changes in n₁₀ and n₀₁ will be described.

<Change in n₁₀>

First, a change in Formula (9) with respect to a change in n₁₀ is considered. Formula (9) is modified into Formula (10) described below.

$$\begin{matrix}[ Formula 10 ] & \\ \frac{2 ( {N}_{f} - {n}_{10} )}{2 {N}_{f} - {n}_{10} + {n}_{01}} = \frac{2 ( 2 {N}_{f} - {n}_{10} + {n}_{01} ) - 2 {N}_{f} - 2 {n}_{01}}{2 {N}_{f} - {n}_{10} + {n}_{01}} = 2 - \frac{2 ( {N}_{f} + {n}_{01} )}{2 {N}_{f} - {n}_{10} + {n}_{01}} & ( 10 )\end{matrix}$$

In Formula (10), when n₀₁ is constant, it can be seen that the value of the above formula monotonically decreases with respect to an increase in n₁₀.

<Change in n₀₁>

Secondly, a change in Formula (9) with respect to a change in n₀₁ is considered. In Formula (9), when n₁₀ is constant, it can be seen that the value of Formula (9) monotonically decreases with respect to an increase in n₀₁. From the above, it can be seen that Formula (7) has a value of 1 with n₁₀=n₀₁=0, monotonically decreases with respect to an increase in n₁₀ and n₀₁, and represents the degree of similarity to solve the problem that the degree of similarity does not change even when n₁₀ and noir which is a problem in the existing technology, change.

### <Exact Meaning of Value Calculated by Divisive Normalization Similarity Calculation Method>

Next, the exact meaning of the value calculated by the divisive normalization similarity calculation method will be described.

The two formulas S_{d} and S_{c} described below are considered.

$$\begin{matrix}[ Formula 11 ] & \\ {S}_{d} = \frac{2 {n}_{11}}{{c}_{1} + {n}_{11} + {n}_{01}} & ( 11 )\end{matrix}$$

Formula (11) is a formula that becomes the divisive normalization similarity calculation method of the present invention when c₁ is n₁₁+n₁₀.

$$\begin{matrix}[ Formula 12 ] & \\ {S}_{c} = \frac{{n}_{11}}{\sqrt{{c}_{2}} \sqrt{{n}_{11} + {n}_{01}}} & ( 12 )\end{matrix}$$

Formula (12) expresses cosine similarity between the vectors x and y when c₂ is n₁₁+n₁₀. Cosine similarity represents the similarity of “how similar” two vectors are. Specifically, it is a cosine value of an angle formed by two vectors in a vector space. This value is calculated by dividing an inner product of two vectors (operation of adding a product of corresponding components of two vectors for all components) by a product of magnitude (norm) of the two vectors.

First, u and v are denoted by n₁₁ and n₀₁, respectively. When these are substituted into the above Formulas (11) and (12), S_{d} and S_{c} are expressed as functions of u and v, and become as described below.

$$\begin{matrix}[ Formula 13 ] & \\ {S}_{d} ( u , v ) = \frac{2 u}{{c}_{1} + u + v} & ( 13 )\end{matrix}$$

$$\begin{matrix}[ Formula 14 ] & \\ {S}_{c} ( u , v ) = \frac{u}{\sqrt{{c}_{2}} \sqrt{u + v}} & ( 14 )\end{matrix}$$

Now, in general, considering up to a linear term as Taylor expansion about (u, v) of the function f(u, v), a Taylor series f⁽¹⁾(u+h, v+k) up to the linear term is expressed as described below.

$$\begin{matrix}[ Formula 15 ] & \\ {f}^{( 1 )} ( u + h , v + k ) = \frac{1}{0 !} f ( u , v ) + \frac{1}{1 !} ( \frac{\partial f ( u , v )}{\partial u} h + \frac{\partial f ( u , v )}{\partial v} k ) & ( 15 )\end{matrix}$$

Using this, Taylor series S_{d}⁽¹⁾(u+h, v+k) and S_{c}⁽¹⁾(u+h, v+k) up to the linear term about (u, v) of S_{d}(u, v) and S_{c}(u, v) are obtained as described below.

$$\begin{matrix}[ Formula 16 ] & \\ {S}_{d}^{( 1 )} ( u + h , v + k ) = \frac{1}{0 !} \cdot \frac{2 u}{{c}_{1} + u + v} + \frac{1}{1 !} \cdot \frac{2}{{( {c}_{1} + u + v )}^{2}} [ ( {c}_{1} + v ) h - uk ] & ( 16 )\end{matrix}$$

$$\begin{matrix}[ Formula 16 ] & \\ {S}_{c}^{( 1 )} ( u + h , v + k ) = \frac{1}{0 !} \cdot \frac{u}{\sqrt{{c}_{2}} \sqrt{u + v}} + \frac{1}{1 !} \cdot \frac{1}{2 \sqrt{{c}_{2}} {( u + ν )}^{\frac{3}{2}}} [ ( u + 2 v ) h - u k ] & ( 17 )\end{matrix}$$

Substituting c₁=c₂=n₁₁+n₁₀=N_{f}, u=N_{f}, and v=0 into the above Formulas (16) and (17) results in the following.

$$\begin{matrix}[ Formula 18 ] & \\ {S}_{d}^{( 1 )} ( {N}_{f} + h , k ) = \frac{]}{0 !} \cdot \frac{2 {N}_{f}}{{N}_{f} + {N}_{f}} + \frac{1}{1 !} \cdot \frac{2}{{( {N}_{f} + {N}_{f} )}^{2}} ( {N}_{f} h - {N}_{f} k ) = 1 + \frac{1}{2 {N}_{f}} ( h - k ) & ( 18 )\end{matrix}$$

$$\begin{matrix}[ Formula 18 ] & \\ {S}_{c}^{( 1 )} ( {N}_{f} + h , k ) = \frac{1}{0 !} \cdot \frac{u}{\sqrt{{c}_{2}} \sqrt{u + v}} + \frac{1}{1 !} \cdot \frac{1}{2 \sqrt{{c}_{2}} {( u + v )}^{\frac{3}{2}}} [ ( u + 2 v ) h - uk ] = \frac{{N}_{f}}{\sqrt{{N}_{f}} \sqrt{{N}_{f}}} + \frac{1}{2 \sqrt{{N}_{f}} {N}_{f}^{\frac{3}{2}}} ( {N}_{f} h - {N}_{f} k ) = 1 + \frac{1}{2 {N}_{f}} ( h - k ) & ( 19 )\end{matrix}$$

Thus, when c₁=c₂=n₁₁+n₁₀=N_{f}, u=N_{f}, and v=0, the following equation holds.

$$\begin{matrix}[ Formula 20 ] & \\ {S}_{d}^{( 1 )} ( {N}_{f} + h , k ) = {S}_{c}^{( 1 )} ( {N}_{f} + h , k ) & ( 20 )\end{matrix}$$

From the above, it can be seen that the value calculated by the divisive normalization similarity determination method of the present invention is an approximate value of cosine similarity. As a result, the similarity calculated by the divisive normalization similarity determination method can calculate the similarity more accurately than the existing technology.

### [Implementation Method]

Hereinafter, an implementation method using a neural network circuit device regarding a divisive normalization similarity calculation method will be described.

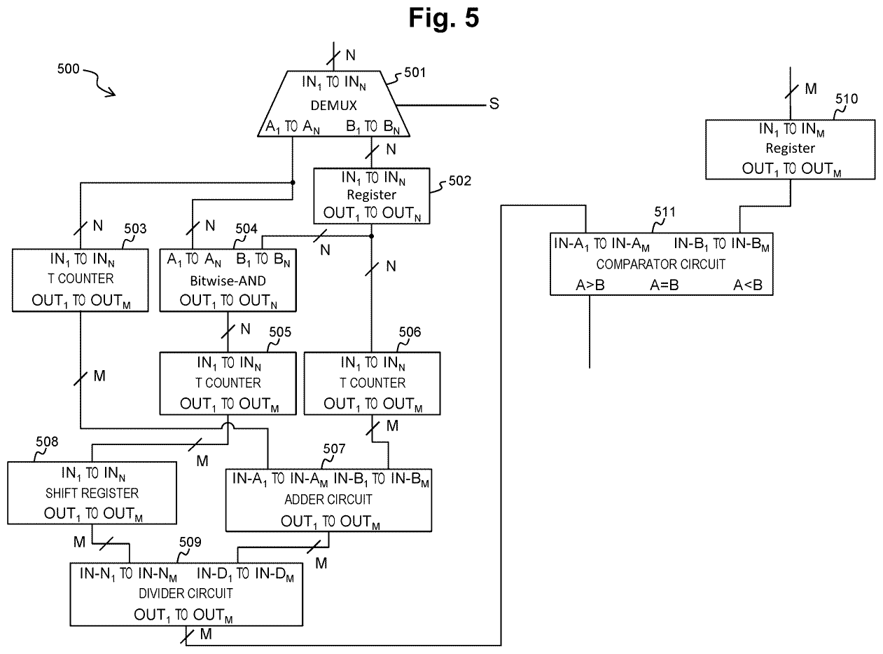

FIG. 5 is a diagram illustrating a neural network circuit device in a case where an activation function is a “step function” for which any threshold can be set in the divisive normalization similarity calculation method.

As illustrated in FIG. 5, a neural network circuit device 500 includes a demultiplexer (DEMUX) 501, registers (Register) 502 and 510, a Bitwise-AND circuit 504 (logical conjunction operation circuit), a T counter 503 (first counter), a T counter 505 (second counter), a T counter 506 (third counter), an adder circuit 507, a shift register 508, a divider circuit 509, and a comparator circuit 511.

The demultiplexer (DEMUX) 501 is a circuit that receives an input vector x=(x₁, x₂, . . . , x_{N})^{T} (feature value) in the learning phase and outputs a signal of the input vector x to one of outputs A₁ to A_{N} and B₁ to B_{N} designated by a phase switching signal S. The phase switching signal S is a switching signal between (learning phase and similarity determination phase (inference phase). The demultiplexer (DEMUX) 501 outputs the signal of the input vector x to the Bᵢ to B_{M} sides in the learning phase, and outputs the signal to the A₁ to A_{M} sides in the similarity determination phase (inference phase).

The demultiplexer (DEMUX) 501 receives an input vector x in the learning phase and outputs an input signal to one of a first output and a second output designated by the phase switching signal.

The registers (Register) 502 and 510 are circuits that temporarily hold an input signal and outputs the input signal at a predetermined timing.

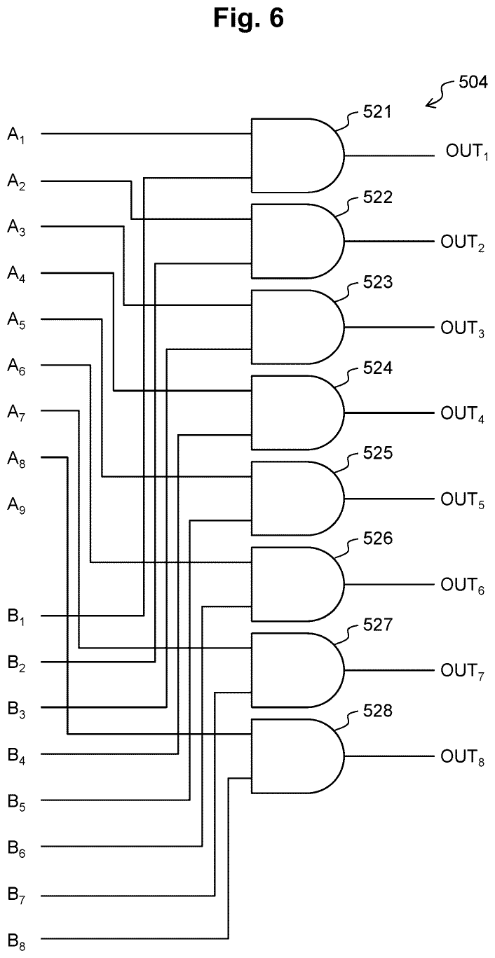

The Bitwise-AND circuit 504 is a circuit that performs a logical conjunction operation (AND) for each corresponding bit regarding two input vectors A₁ to A_{M} and B₁ to B_{M} and outputs the values from OUT₁ to OUT_{M} (see FIG. 6 described below). The Bitwise-AND circuit 504 partially calculates a vector inner product by calculating a logical product (AND) of the stored vector of the learning phase and the vector of the inference phase in units of 1 bit. In addition, it is also possible to calculate the vector inner product by a combination of the Bitwise-AND circuit 504 and the calculation by the T counter.

The Bitwise-AND circuit 504 is a logical conjunction operation circuit that calculates a logical product of the vector of the learning phase and the vector of the inference phase.

The T counters 503, 505, and 506 are circuits that calculate the number of inputs of logical variables having a value of 1 input to inputs IN₁ to IN_{N}, and outputs the values from OUT₁ to OUT_{M}. The T counter 503 counts the number of inputs of the input vector signals having a value of 1 coming in the inference phase.

The T counter 506 counts the number of inputs of the input vector signals having a value of 1 at the time of learning. The T counter 505 counts the number of 1s in the logical conjunction operation (AND) performed by the Bitwise-AND circuit 504.

The adder circuit 507 adds the output of the T counter 503 and the output of the T counter 506. A denominator ∥w∥²+∥y∥² of Formula (6) is calculated and output.

When the result of the T counter 505 is an integer value represented in binary numbers, the shift register 508 shifts the input vector signal by 1 bit to the Most Significant Bit (MSB) side, thereby outputting a value that is twice the value calculated by the T counter 505. Here, the MSB side is a high-order side, and is a left side when represented in binary numbers. The shift register 508 outputs a value that is twice the value calculated by second counter 505 as a numerator of Formula (6).

The divider circuit 509 receives input values 2(w·y) and ∥w∥²+∥y∥² from the shift register 508 and the adder circuit 507, respectively, and divides 2 (w·y) by ∥w∥²+∥y∥².

The register (Register) 510 is a circuit that temporarily holds and outputs an input signal that is a threshold.

The comparator circuit 511 compares the division result (calculated similarity) of the divider circuit 509 with the value (threshold) stored in the register 510, and outputs 1 when the similarity is larger than the threshold, and outputs 0 otherwise.

### [Operation]

The operation of the neural network circuit device 500 configured as described above will be described below.

### <Learning Phase>

First, the input vector x=(x₁, x₂, . . . , x_{N}) T in the learning phase is received by the demultiplexer 501. The demultiplexer 501 outputs the input signal to one of the outputs A₁ to A_{N} and B₁ to B_{N}. To which one to output is designated by the phase switching signal S input to the demultiplexer 501. The phase switching signal S is a signal for distinguishing the learning phase and the similarity determination phase. When this signal is the value of the signal indicating the learning phase, the input vector x is transmitted from the outputs B to BN to the register 502. At this time, the register 502 stores the value of the input vector x and outputs the value from OUT₁ to OUT_{N}.

In the present embodiment, since the synaptic weight is determined as w=x, x stored in the register 502 is set as w=(w₁, w₂, . . . w_{N}). The output of the register 502 is transmitted to the Bitwise-AND circuit 504 (logical conjunction operation element) and the T counter 506. The Bitwise-AND circuit 504 performs a logical conjunction operation (AND) for each corresponding bit regarding two inputs.

The T counters 503, 505, and 506 calculate the number of inputs of the input vector signals of the logical variables having a value of 1 input to inputs IN₁ to IN_{N}, and outputs the values from OUT₁ to OUT_{M}.

Among the Bitwise-AND circuit 504 and the T counters 503, 505, and 506, an example of the Bitwise-AND circuit 504 will be described with reference to FIG. 6.

FIG. 6 is a diagram for describing a method of achieving Bitwise-AND of the Bitwise-AND circuit 504.

The Bitwise-AND circuit 504 includes AND circuits 521 to 528 that perform a logical conjunction operation (AND) of two sets of inputs A₁, A₂, A₃, A₄, A₅, A₆, A₇, and A₈ and B₁, B₂, B₃, B₄, B₅, B₆, B₇, and B₈, and outputs one set of outputs OUT₁, OUT₂, OUT₃, OUT₄, OUT₅, OUT₆, OUT₇, and OUT₈.

The AND circuits 521 to 528 calculate the one set of outputs OUT₁, OUT₂, OUT₃, OUT₄, OUT₅, OUT₆, OUT₇, and OUT₈ from the two sets of inputs A₁, A₂, A₃, A₄, A₅, A₆, A₇, and A₈ and B₁, B₂, B₃, B₄, B₅, B₆, B₇, and B₈. In the calculation to be executed, the value of OUTᵢ is the result of the logical conjunction operation of logical variables Aᵢ and Bᵢ. Here, i is an integer of 1 to 8.

Referring back to FIG. 5, the T counters 503, 505, and 506 can be achieved by a look-up table (LUT). The look-up table is a circuit having a table that outputs a combination of arbitrary logical variables for a combination of logical variables. This circuit can be achieved by memory.

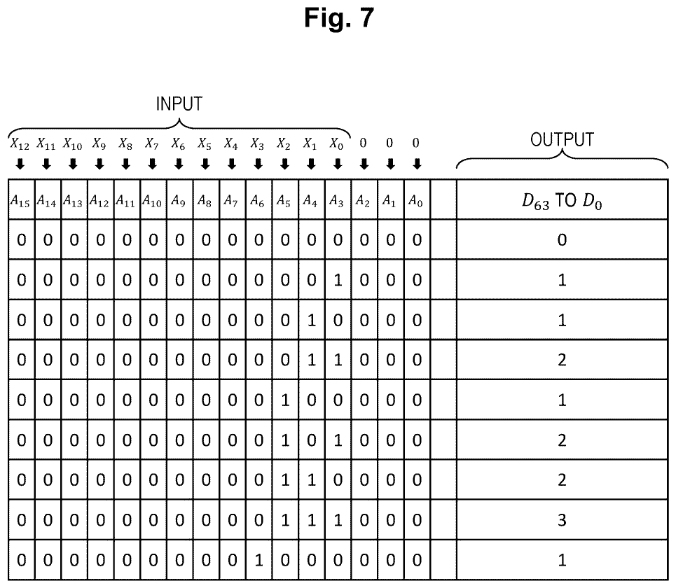

FIG. 7 is a diagram for describing a method of achieving the T counters 503, 505, and 506. FIG. 7 is an example illustrating to which address and which value is input when creating a look-up table using memory.

The memory stores data represented by a combination of arbitrary logical variables with an address represented by a combination of a plurality of logical variables as an input, and outputs the data stored in the designated address at the time of reading. In the example of FIG. 7, the addresses are expressed by a combination of logical variables A₀ to A₁₅, and each address corresponds to a storage location of 1-byte data. Then, at the time of reading data from the memory, data of 8 bytes (64 bits of D₀ to D₆₃) starting from the designated address is output. For example, in FIG. 7, 1 is stored in an address at which A₁₅ A₁₄ A₁₃ A₁₂ A₁₁ A₁₀ A₉ A₈ A₇ A₆ A₅ A₄ A₃ A₂ A₁ A₀ are 0000000000001000. This indicates that data representing 1 is stored in 8 bytes (64 bits) of the addresses 0000000000001000 to 0000000000001111.

When a signal in which the inputs to A₂ A₁ A₀ are always 0 is connected to the memory and the inputs from the outside, X₁₂ X₁₁ X₁₀ X₉ X₈ X₇ X₆ X₅ X₄ X₃ X₂ X₁ X₀, are connected to A₁₅ A₁₄ A₁₃ A₁₂ A₁₁ A₁₀ A₉ A₈ A₇ A₆ A₅ A₄ A₃ of the memory, arbitrary 8-byte data can be output with respect to an arbitrary combination of the logical variables of the inputs from the outside. FIG. 7 illustrates a state in which, assuming that X₁₂ X₁₁ X₁₀ X₉ X₈ X₇ X₆ X₅ X₄ X₃ X₂ X₁ X₀ are a binary number, when the value expressed in decimal numbers is 0, 1, 2, 3, 4, 5, 6, 7, 8, or 9, the number of 1s included in the bit string of X₁₂ X₁₁ X₁₀ X₉ X₈ X₇ X₆ X₅ X₄ X₃ X₂ X₁ X₀ is stored as 8-byte data corresponding to D₀ to D₆₃. In FIG. 7, regarding what values are to be put into the 64 bits of D₀ to D₆₃, when Do is a Least Significant Bit (LSB) and D₆₃ is a Most Significant Bit (MSB), FIG. 7 illustrates values obtained by expressing the numerical values when D₀ to D₆₃ are considered as binary numbers in decimal numbers.

Referring back to FIG. 5, based on the above operation, the T counter 506 calculates ∥w∥² included in Formula (6) described above for the synaptic weight w.

### <Similarity Determination Phase>

Next, in the similarity determination phase, when an input vector y is input to the demultiplexer 501, the input vector y is output to A₁ to A_{N} on the basis of the phase switching signal S. This output is sent to the T counter 503 and the Bitwise-AND circuit 504. The T counter 503 calculates ∥y∥² included in Formula (6) described above from the input y by an operation similar to that of the T counter 506.

The synaptic weight w and the input vector y of the similarity determination phase are input to the Bitwise-AND circuit 504, and (w₁y₁, w₂y₂, . . . , w_{N}y_{N})^{T} is calculated. This result is input to the T counter 505. Since w₁y₁ is 0 or 1, the result of the T counter 505 is a calculation result of w₁y₁+w₂y₂+ . . . +w_{N}y_{N}=w·y included in Formula (6) described above. The result of the T counter 505 is further sent to the shift register 508.

In a case where the result of the T counter 505 is an integer value represented in binary numbers, the shift register 508 shifts the input vector signal by 1 bit to the MSB side, so that a value that is twice the value calculated by the T counter 505 can be obtained. This value is a value 2 (w·y) of the numerator of Formula (6) described above.

Outputs of the T counter 503 and the T counter 506 are ∥y∥² and ∥w∥², respectively, and are sent to the adder circuit 507. The adder circuit 507 calculates and outputs the denominator ∥w∥²+∥y∥² of Formula (6). The divider circuit 509 receives input values 2 (w·y) and ∥w∥²+∥y∥² from the shift register 508 and the adder circuit 507, respectively. Then, a division operation of dividing 2 (w·y) by ∥w∥²+∥y∥² is performed. Through the above processing, the divider circuit 509 calculates the similarity and outputs the result.

In the register 510, a threshold of the activation function is input in advance, and its value is stored. As a result, the calculated similarity and threshold are sent to inputs IN-A₁ to IN-A_{M} and IN-B₁ to IN-B_{M} and compared with each other in the comparator circuit 511. The output A>B is 1 when the values input to IN-A₁ to IN-A_{M} are larger than the values input to IN-B₁ to IN-B_{M} as the comparison result, the output A=B is 1 when the values are equal, and the output A<B is 1 when the values input to IN-A₁ to IN-A_{M} are smaller than the values input to IN-B₁ to IN-B_{M}. As a result, the comparator circuit 511 outputs 1 when the similarity is larger than the threshold, and outputs 0 otherwise.

That is, the comparator circuit 511 compares a numerical value (representing “similarity”) represented by a plurality of bits of the divider circuit 509 with a numerical value (representing “threshold”) represented by a plurality of bits.

### Second Embodiment

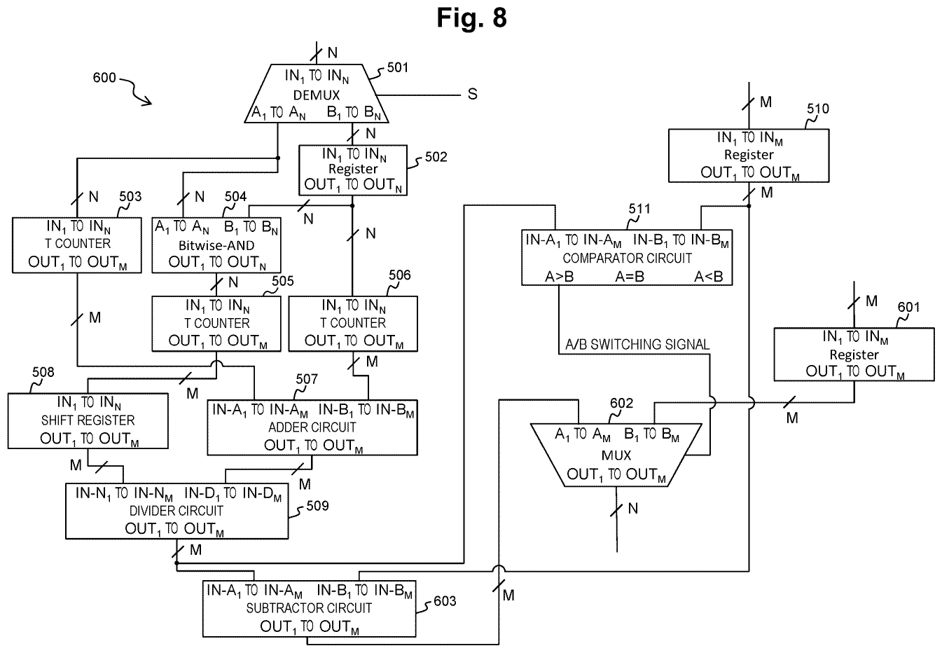

FIG. 8 is a diagram illustrating a neural network circuit device 600 in a case where an activation function is a “linear function” for which any threshold can be set in a divisive normalization similarity calculation method according to the second embodiment of the present invention. The same components as those in FIG. 5 are denoted by the same reference numerals, and redundant description will be omitted.

As illustrated in FIG. 8, the neural network circuit device 600 includes a demultiplexer (DEMUX) 501, registers (Register) 502 and 510, a Bitwise-AND circuit 504, T counters 503, 505, and 506, an adder circuit 507, a shift register 508, a divider circuit 509, a comparator circuit 511, a register 601, a multiplexer (MUX) 602, a subtractor circuit 603.

The register 601 stores an output value when the similarity is less than the threshold.

The subtractor circuit 603 subtracts the threshold of the activation function stored in the register 510 from the calculation result of the divider circuit 509, and outputs a difference of how much the calculation result of the divider circuit 509 exceeds the threshold to the multiplexer 602.

On the basis of an A/B switching signal (when similarity is larger than threshold: 1, otherwise: 0) from the comparator circuit 511, the multiplexer (MUX) 602 outputs the calculation result of the subtractor circuit 603 when the A/B switching signal is 1 and the similarity is larger than the threshold, and outputs the output value stored in the register 601 when the A/B switching signal is 0.

### [Operation]

The operation of the neural network circuit device 500 configured as described above will be described below.

As illustrated in FIG. 8, the input is input to the demultiplexer 501. The operation from this input to the output of the divider circuit 509 is the same as that from the demultiplexer 501 to the output of the divider circuit 509 in FIG. 5.

The output of the divider circuit 509 represents similarity. The output of the divider circuit 509 is sent to the subtractor circuit 603 and the comparator circuit 511. In addition to the subtractor circuit 603, the comparator circuit 511 receives an input from the register 510. The register 510 stores a threshold of the activation function similarly to the register 510 of FIG. 5. The threshold is input in advance similarly to the case of FIG. 5, and the stored threshold is output.

Inputs from the divider circuit 509 and the register 510 are received by IN-A₁ to IN-A_{M} and IN-B₁ to IN-B_{M} of the comparator circuit 511, respectively. In the operation of the comparator circuit 511, similarly to the comparator circuit 511 of FIG. 5, the output vector signal of the divider circuit 509 is compared with the threshold (stored in the register 510) of the activation function. Then, the output A>B is 1 when the values input to IN-A₁ to IN-A_{M} are larger than the values input to IN-B₁ to IN-B_{M} as the comparison result, the output A=B is 1 when the values are equal, and the output A<B is 1 when the values input to IN-A₁ to IN-A_{M} are smaller than the values input to IN-B₁ to IN-B_{M}. As a result, the output of the comparator circuit 511 is 1 when the output of the divider circuit 509 is equal to or larger than the threshold stored in the register 510, and is 0 otherwise.

The output of the comparator circuit 511 is connected to the multiplexer 602, and one of the two systems of the inputs A₁ to A_{M} and B₁ to B_{M} is output from the outputs OUT₁ to OUT_{M}. The value of the output of the comparator circuit 511 is input to the multiplexer, and which one of the two systems to output is switched according to the value. When this value is 1, A₁ to A_{M} are output to OUT₁ to OUT_{M}, and when this value is 0, B₁ to B_{M} are output to OUT₁ to OUT_{M}.

The outputs of the subtractor circuit 603 are connected to the inputs A₁ to A_{M} of the multiplexer 602. The divider circuit 509 calculates similarity. This value is sent to the inputs IN-A₁ to IN-A_{M} of the subtractor circuit 603. In addition, the threshold stored in the register 510 is input to the inputs IN-B₁ to IN-B_{M} of the subtractor circuit 603. As a result, the output of the subtractor circuit 603 becomes a value obtained by subtracting the threshold from the similarity, and this value is sent to the multiplexer 602. The value stored in the register 601 is sent to the inputs B₁ to B_{M} of the multiplexer 602. The register 601 stores an output value when the similarity is less than the threshold in advance of circuit use. When the linear function is used as the activation function, the value 0 is stored in the register 601.

### Third Embodiment

In the present embodiment, an example in which replacement is performed with a divider circuit that performs division at high speed in the first embodiment and the second embodiment will be described.

The divisor of the division used in the present embodiment is ∥w∥²+∥y∥² as described in Formula (6) described above. Regarding ∥w∥² included in this divisor, when an arbitrary i-th component of w is wᵢ, the value of wᵢ is wᵢ=0 or wᵢ=1, and thus ∥w∥²=w₁+w₂+w₃+ . . . holds. In addition, also regarding ∥y∥², when an arbitrary i-th component of y is yᵢ, yᵢ=0 or yᵢ=1, and thus ∥y∥²=y₁+y₂+y₃+ . . . holds. Thus, it becomes the number of components of 1 among the components of the synaptic weight vector w and the input vector y of the similarity determination phase. Therefore, when the number of inputs to the perceptron is N, the range of the number of components of 1 among the components of w and y is an integer from 0 to N. Thus, the range of ∥w∥²+∥y∥² is an integer from 0 to 2N. As a result, since the number of different divisors is 2N+1 at the maximum, it is possible to perform division at high speed using this fact as described below.

In general, when division and multiplication are compared, multiplication can perform arithmetic processing faster. Since the division can be achieved by calculating the reciprocal of the divisor and multiplying the value by the dividend, it is possible to increase the speed using this characteristic. That is, first, the reciprocal of all the candidates for the divisor is calculated in advance, and the calculated reciprocal is stored in the memory. Then, in the divisive normalization similarity calculation, division is performed using the value of the reciprocal stored in the memory and a multiplier circuit.

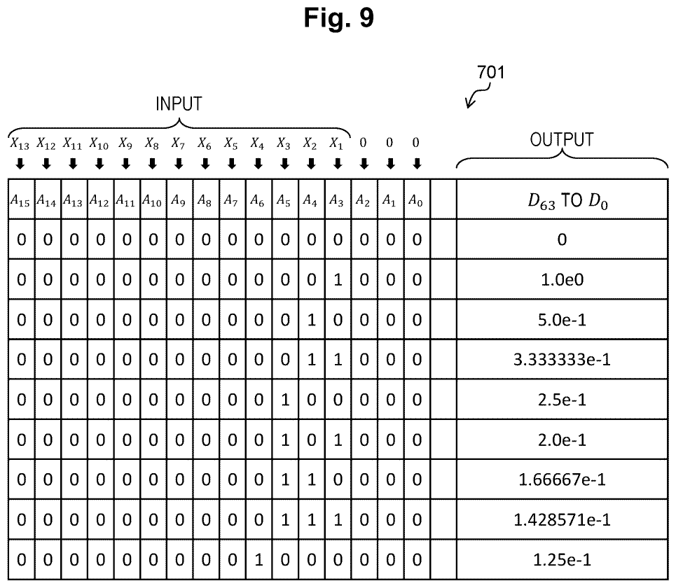

FIG. 9 is a diagram illustrating an example of a memory configuration for storing a reciprocal of a divisor by a method for storing in memory a reciprocal of a denominator ∥w∥²+∥y∥² of Formula (6).

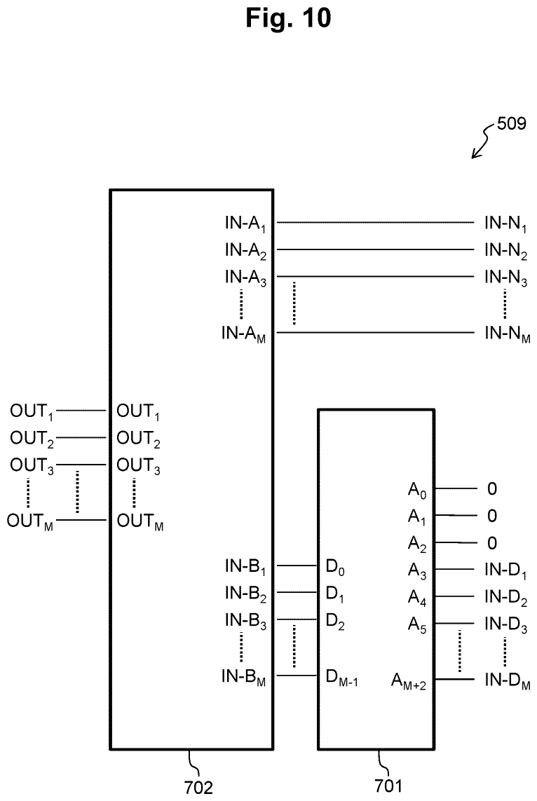

As illustrated in FIG. 10, a reciprocal of each divisor represented by 8 bytes is stored in memory 701 having 16 bit address signals represented by A₁₅, A₁₄, . . . . A₀. Since the reciprocal of each divisor is represented by 8 bytes, the address storing the reciprocal of each divisor is every 8 bytes. From this, addresses necessary to actually identify each divisor are A₁₅, A₁₄, . . . A₃. On the other hand, when an integer representing ∥w∥²+∥y∥² is represented by 13 bits, and x₁₃, x₁₂, . . . x₁ represent each bit, by connecting xᵢ to A₍ᵢ₊₂₎, a divisor represented by the integer is used as an input, and a reciprocal of the divisor can be extracted as a data signal. In FIG. 10, 0 is stored as data for addresses in which A₁₅, A₁₄, . . . A₀ are all 0. This means that ∥w∥²+∥y∥²⁼⁰. In this case, since the components of w and y are all 0 and do not affect the similarity, it is assumed that such an input does not exist.

FIG. 10 is a circuit diagram illustrating an example of a configuration of the divider circuit 509 by a method for storing in the memory 701 the reciprocal of the denominator ∥w∥²+∥y∥² of Formula (6).

As illustrated in FIG. 10, the divider circuit 509 includes the memory 701 and a multiplier circuit 702.

As illustrated in FIG. 10, in the divider circuit 509, divisors are input to IN-D₁, IN-D₂, . . . IN-D_{M}, and input to A₃, A₄, . . . A_{M+2} of the memory 701, respectively. The memory 701 outputs the reciprocal of the divisor to Do, D₁, . . . D_{M-1}, and the outputs are input to IN-B₁, IN-B₂, . . . IN-B_{M} of the multiplier circuit 702. Dividends IN-N₁, IN-N₂, . . . IN-N_{M} are directly input to IN-A₁, IN-A₂, . . . . IN-A_{M} of the multiplier circuit 702. Based on these inputs, the product of the dividend and the reciprocal of the divisor is calculated by the multiplier circuit 702 and output from OUT₁, OUT₂, . . . OUT_{M}.

### Effects of First to Third Embodiments

As described above, the neural network circuit device 500 that calculates the degree of similarity between the input of the learning phase and the input of the inference phase using a perceptron obtained by modeling a nerve cell, the neural network circuit device including the logical conjunction operation circuit (Bitwise-AND circuit 504) that calculates a logical product between the vector of the learning phase and the vector of the inference phase, the first counter (T counter 503) that counts the number of inputs of input vectors having a value of 1 at the time of the inference phase, a second counter (second counter 505) that counts the number of inputs of logical product vectors having a value of 1 obtained by the logical conjunction operation by the logical conjunction operation circuit, a third counter (third counter 506) that counts the number of inputs of vectors having a value of 1 at the time of the learning phase, the adder circuit 507 that adds the output of the first counter and the output of the third counter, the shift register 508 that shifts the result of the second counter to a high-order side by 1 bit, and the divider circuit 509 that divides the output vector of the shift register 508 by the output vector of the adder circuit 507.

For example, a neural network circuit device that calculates the degree of similarity between the input of the learning phase and the input of the similarity determination phase using a perceptron obtained by modeling a nerve cell, the neural network circuit device including a logic circuit that receives one or more input values, and when one of a value L and a value H is input to each input value, a value of a logical variable representing an i-th input among N inputs of the learning phase is xᵢ, a value of a logical variable representing an i-th input among N inputs of the similarity determination phase is yᵢ, and a value of a weight assigned to the i-th input of the similarity determination phase is wᵢ, constitutes Formula (6) that incorporates, into a model of the perceptron, an operation caused by a phenomenon called a shunt effect of the nerve cell in the similarity determination phase, and the logic circuit calculates the divisive normalization similarity.

In this way, the similarity calculated by the divisive normalization similarity calculation method can calculate the similarity more accurately than the existing technology. Thus, the similarity between the information stored in the learning phase and the information input to the similarity determination phase can be accurately measured by the divisive normalization similarity calculation method. As a result, in an artificial neural network including a perceptron obtained by modeling a nerve cell, a circuit device that accurately determines similarity between information stored in the network and information newly input to the network can be achieved.

In the neural network circuit device 500 (FIGS. 5 to 10) according to the first to third embodiments, the logic circuit includes the logical conjunction operation circuit (Bitwise-AND circuit 504) that calculates a vector inner product by performing a logical conjunction operation of the vector of the learning phase and the vector of the inference phase in units of 1 bit, the first counter (T counter 503) that counts the number of input logical variables having a value of 1 at the time of the inference phase, the second counter (second counter 505) that counts the number of 1s in the vector inner product obtained by the logical conjunction operation in the logical conjunction operation circuit, a third counter (third counter 506) that counts the number of vectors of 1 at the time of the learning phase, the adder circuit 507 that calculates the denominator of Formula (6) by adding the output of the first counter 503 and the output of the third counter 506, the shift register 508 that shifts the result of the second counter 505 to an MSB side by 1 bit to output a value that is twice the value calculated by the second counter 505 as the numerator of Formula (6), and the divider circuit 509, the divider circuit 509 receiving the input value 2 (w·y) and ∥w∥²+∥y∥² from the shift register 508 and the adder circuit 507, respectively, and divides the input value 2 (w·y) by ∥w∥²+∥y∥².

In this way, it is possible to achieve a circuit device that accurately determines a difference between an input vector at the time of learning and an input vector at the time of similarity determination with the logic circuit when determining the inner product similarity.

In the neural network circuit device 500 (FIGS. 5 to 10) according to the first to third embodiments, the logic circuit includes the demultiplexer 501 that receives an input vector x in the learning phase and outputs an input signal to one of a first output and a second output designated by the phase switching signal S.

In this way, the demultiplexer 501 can receive an input vector x=(x₁, x₂, . . . , x_{N})^{T} (feature value) in the learning phase and outputs an input signal to one of outputs A₁ to A_{N} and B₁ to B_{N} designated by the phase switching signal S.

In the neural network circuit device 500 (FIGS. 5 to 10) according to the first to third embodiments, the divider circuit 509 includes a storage unit or a storage (memory 701) that stores the reciprocal of the divisor and the multiplier circuit 702 that multiplies the reciprocal of the divisor read from the storage unit.

In this way, a look-up table (LUT) is used instead of the logic gate as the multiplier circuit 702. The LUT is a basic component of a field programmable gate array (FPGA) which is an accelerator, has high affinity at the time of FPGA synthesis, and is easily implemented by the FPGA. In addition, as the accelerator, a graphics processing unit (GPU)/an application specific integrated circuit (ASIC) or the like may be used.

The neural network circuit device 500 (FIGS. 5 to 10) according to the first to third embodiments further includes the comparator circuit 511 that compares the output vector of the divider circuit 509 with a threshold vector.

In this way, the comparator circuit 511 can compare the division result (calculated similarity) of the divider circuit 509 with the value (threshold) stored in the register 510, and output 1 when the similarity is larger than the threshold, and output 0 otherwise.

The neural network circuit device 500 (FIGS. 5 to 10) according to the first to third embodiments includes the subtractor circuit 603 that subtracts the threshold from the output vector of the divider circuit 509, and the multiplexer 602 that switches and outputs an output vector of the subtractor circuit 603 and a predetermined value according to the output of the comparator circuit 511.

In this way, the value stored in the register 601 is sent to the input of the multiplexer 602. The register 601 can store an output value when the similarity is less than the threshold in advance of circuit use, and can flexibly and adaptively cope with a case of using a linear function as the activation function, a case of using another activation function, and the like.

### Fourth Embodiment

In the fourth embodiment, [noise addition sensitivity characteristic improvement method] is further combined with [divisive normalization similarity determination method] and [diffusive learning network method] of the first to third embodiments.

[Divisive normalization similarity determination method] and [diffusive learning network method] are the same as those of the first to third embodiments, and thus the description thereof will be omitted.

First, the noise addition sensitivity characteristic improvement method will be described.

In general, the sensitivity of a measuring instrument is represented by a ratio of an indication amount of the measuring instrument to an observation value. On the other hand, [divisive normalization similarity determination method] and [diffusive learning network method] described in the first to third embodiments can be regarded as a measuring instrument for measuring the similarity between data of the learning phase and the similarity determination phase.

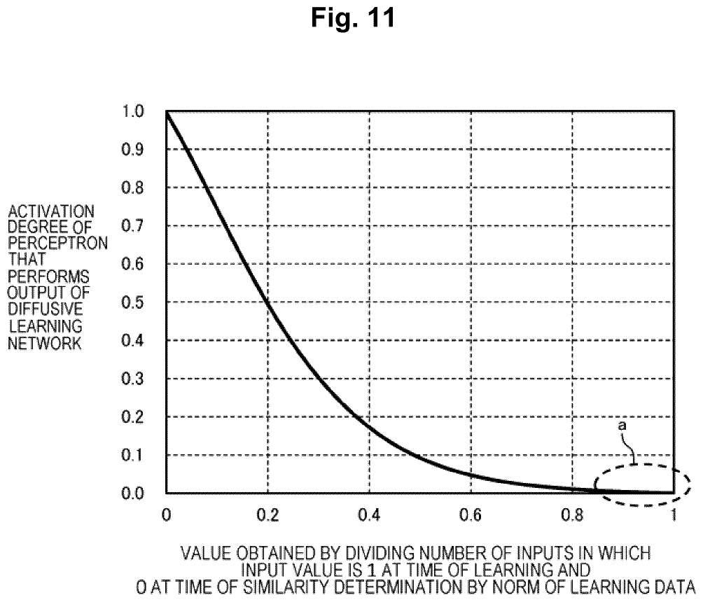

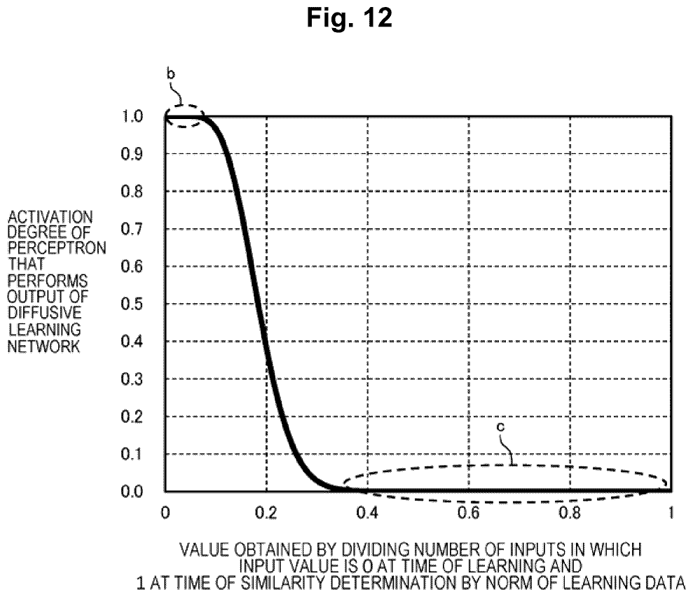

FIGS. 11 and 12 are used to describe characteristics of the measuring instrument.

FIG. 11 is a diagram illustrating an activation degree (N=100) of a perceptron that performs the output of the diffusive information network when only the divisive normalization similarity calculation method and the diffusive learning network are used. FIG. 12 is a diagram illustrating an activation degree (N=1000) of a perceptron that performs the output of the diffusive information network when only the divisive normalization similarity calculation method and the diffusive learning network are used.

FIGS. 11 and 12 illustrate that the difference in data between the learning phase and the similarity determination phase increases as the horizontal axis goes to the right. The vertical axis represents the similarity calculated when [divisive normalization similarity determination method] and [diffusive learning network method] are used. The activation function used in FIGS. 11 and 12 is a sigmoid function. The sigmoid function is expressed by Formula (21) described below. In this formula, β and t are a parameter representing a gradient and a threshold, respectively.

$$\begin{matrix}[ Formula 21 ] & \\ f ( x ) = \frac{1}{1 + {e}^{- β ( x - τ )}} & ( 21 )\end{matrix}$$

Parameters included in Formula (21) are p=0.05, β=1.0×10⁴, and t=0.9. In addition, the value of N is 100 and 1000 in FIGS. 11 and 12, respectively. As indicated by the broken line circle a in FIG. 11 and the broken line circles b and c in FIG. 12, the gradient of the curve is almost 0 and is nearly horizontal at the positions where the activation degree of the perceptron is close to 0.0 and the activation degree of the perceptron is close to 1.0.

The fact that the gradient of the curve illustrated in FIG. 11 is horizontal means that the similarity calculated by the difference in data between the learning phase and the similarity determination phase does not change and the sensitivity is poor. As described above, in a case where only [divisive normalization similarity determination method] and [diffusive learning network method] of the first embodiment are used, a problem that a part having poor sensitivity for partially measuring similarity is generated (Note 1) occurs.

In addition, comparing FIGS. 11 and 12, different curves are obtained due to a difference in N representing the square of the norm of the learning data. For example, when the value of the horizontal axis is 0.3, the values of the vertical axis are 0.302 and 0.0287 in FIGS. 11 and 12, respectively. Therefore, in a case where various pieces of learning data have different values of N, even when the same level of difference occurs in terms of the rate with respect to the data at the time of learning, different similarities are output. This causes a problem that it becomes difficult to compare the similarities with different learning data having different values of N (Note 2).

Further, Formula (7) used in [divisive normalization similarity determination method] of the first embodiment is an approximation of cosine similarity that is mathematically defined and whose characteristics are sufficiently analyzed and whose effectiveness is shown. However, after the activation degree is calculated by Formula (7), conversion is performed by an activation function, and in addition, processing is performed by [diffusive learning network method] of the first embodiment, thereby causing a problem that mathematically defined characteristics become unclear (Note 3).

Hereinafter, [noise addition sensitivity characteristic improvement method] described in the fourth embodiment is a technique for solving these Notes 1 to 3.

In [noise addition sensitivity characteristic improvement method], after the calculation of similarity Sd represented by Formula (7) used in [divisive normalization similarity determination method] and [diffusive learning network method] of the first embodiment is performed, similarity Sg obtained by adding noise to Sd is calculated as in Formula (22) described below.

$$\begin{matrix}[ Formula 22 ] & \\ {S}_{g} = {S}_{d} + G = \frac{2 {n}_{11}}{2 {n}_{11} + {n}_{10} + {n}_{01}} + G & ( 22 )\end{matrix}$$

Here, when a probability density function that generates a random variable X is represented by P(X), G is a value of the random variable randomly generated according to the probability density function. This value is newly generated every time Sg is calculated. In addition, after calculating Sg, Sg is used instead of Sd when performing the processing of [divisive normalization similarity determination method] and [diffusive learning network method].

In this way, the expected value of the output of the divisive normalization similarity calculation unit when Sg is used instead of Sd is considered. In a certain divisive normalization similarity calculation unit, a probability that the random variable X occurs is P(X)dX. Assuming that S(n, d, 1) and f(·) represent the activation degree and the activation function in the case of not adding noise, respectively, the output of the divisive normalization similarity calculation unit is f(S(n, d, 1)+X) in the case of using S. In this, the value G of the randomly generated random variable described above is represented by X.

Now, in a case where there are a sufficiently large number of divisive normalization similarity calculation units, it can be considered that there are also a sufficient number of divisive normalization similarity calculation units in which the activation degree S(n, d, 1) is the same. Thus, the expected value of the output of the divisive normalization similarity calculation unit having the activation degree of S(n, d, 1) is expressed by Formula (23).

$$\begin{matrix}[ Formula 23 ] & \\ {\int }_{- ∞}^{+ ∞} f ( S ( n , d , l ) + X ) P ( X ) dX & ( 23 )\end{matrix}$$

Further, regarding the probability that the activation degree is S(n, d, 1), when the probability that the activation degree is S(n, d, 1) is used, the expected value of the output of the divisive normalization similarity calculation unit can be expressed by Formula (24) as described below.

$$\begin{matrix}[ Formula 24 ] & \\ {\sum }_{n = 0}^{N + k} [ {}_{N + k} {C}_{n} \cdot {{p}^{n} ( 1 - p )}^{N + k - n} \cdot {\sum }_{𝒞} \frac{{}_{N - m} {C}_{n - d - l} \cdot {}_{m} {C}_{d} \cdot {}_{k} {C}_{l}}{{}_{N + k} {C}_{n}} {\int }_{- ∞}^{+ ∞} f ( S ( n , d , l ) + X ) P ( X ) d X ] & ( 24 )\end{matrix}$$

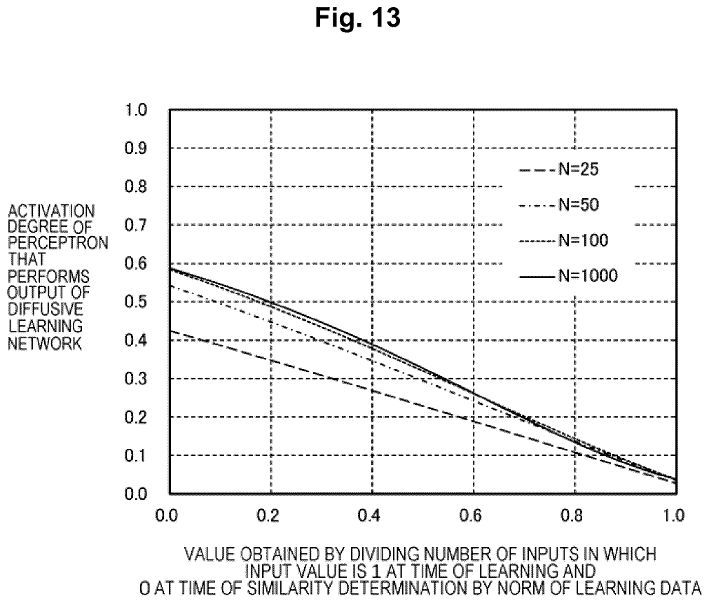

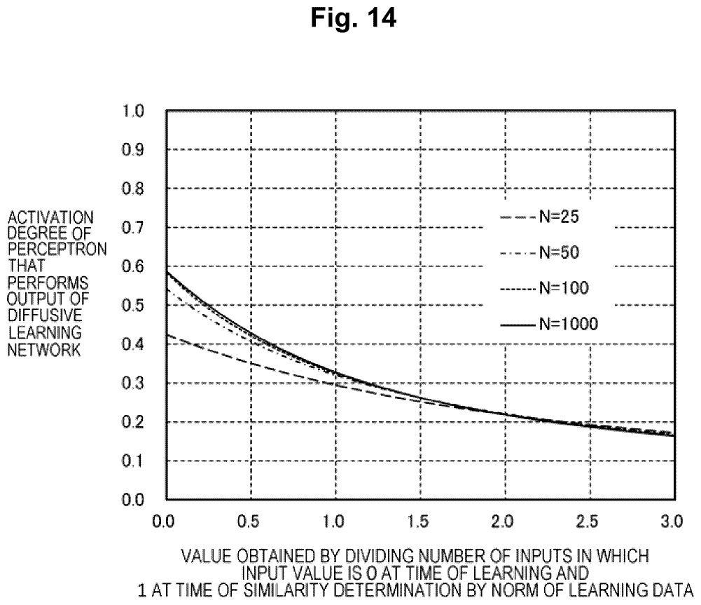

Features of the similarity actually calculated by the divisive normalization similarity calculation unit using Formula (24) will be described with reference to FIGS. 13 and 14.

FIG. 13 is a diagram illustrating an activation degree (output change when the number of inputs in which input value is 1 at the time of learning and 0 at the time of similarity determination is changed) of the perceptron that performs output of the diffusive information network when the divisive normalization similarity calculation method, the diffusive learning network, and the noise addition sensitivity characteristic improvement method are used. FIG. 14 is a diagram illustrating an activation degree (output change when the number of inputs in which input value is 0 at the time of learning and 1 at the time of similarity determination is changed) of the perceptron that performs output of the diffusive information network when the divisive normalization similarity calculation method, the diffusive learning network, and the noise addition sensitivity characteristic improvement method are used.

In FIGS. 13 and 14, the vertical axis represents the activation degree of the perceptron that performs output of the diffusive learning network, and the horizontal axis represents the rate at which the data in the similarity determination phase is different from the data in the learning phase.

In FIGS. 13 and 14, a sigmoid function is used as the activation function, and the parameters included in Formula (24) and the parameter included in Formula (21) representing f(·) included in Formula (24) are p=0.05, 3=1.0×10⁴, and t=0.9. In addition, regarding the value of N, cases of 25, 50, 100, and 1000 are illustrated. Further, for the probability density function P(X) in Formula (24), a probability density function of Gaussian distribution with an average value and standard deviation of 0.01 and 0.5, respectively, are used.

FIGS. 13 and 14 illustrate that the difference in data between the learning phase and the similarity determination phase increases as the horizontal axis goes to the right. The vertical axis represents the activation degree of the perceptron that performs output of the diffusive learning network that is calculated by Formula (24).

As can be seen from FIGS. 13 and 14, the activation degree of the perceptron that performs output of the diffusive learning network always has a negative gradient with respect to an increase in value on the horizontal axis. From this, it can be seen that the problem of (Note 1) a part having poor sensitivity for partially measuring similarity is generated has been solved by setting the activation degree of the perceptron that performs output of the diffusive learning network as the similarity. Further, in FIGS. 13 and 14, when N=100 or more, they hardly depend on N, and it can be seen that the problem of (Note 2) it becomes difficult to compare the similarities with different learning data having different values of N has been solved.

In order to describe that (Note 3) has been solved, a method of representing the degree of similarity between two sets called Tanimoto similarity or Jaccard similarity described in Non Patent Literature 6 and Non Patent Literature 7 will be described.

In the present specification, these similarities that are equivalent definitions are abbreviated as Tanimoto similarity. Now, two sets A and B are considered. Tanimoto similarity S_{T} is expressed by Formula (25) described below.

$$\begin{matrix}[ Formula 25 ] & \\ {S}_{T} = \frac{\vert A ⋂ B \vert}{\vert A \vert + \vert B \vert - \vert A ⋂ B \vert} & ( 25 )\end{matrix}$$

In Formula (25), |A| represents the number of elements included in the set A. Here, it is considered to express the Tanimoto similarity Sr using the symbols used in Formula (7). In this case, when the two sets are considered as a set of components having a value of 1 in the input vector w of the learning phase and a set of components having a value of 1 in the input vector y of the similarity determination phase, |A∩B|=n₁₁, |A|=n₁₁+n₁₀, |B|=n₁₁+n₀₁ are obtained using the symbols used in Formula (7). When these are substituted into Formula (25), Formula (26) described below is obtained.

$$\begin{matrix}[ Formula 26 ] & \\ {S}_{T} = \frac{{n}_{11}}{{n}_{11} + {n}_{10} + {n}_{11} + {n}_{01} - {n}_{11}} = \frac{{n}_{11}}{{n}_{11} + {n}_{10} + {n}_{01}} & ( 26 )\end{matrix}$$

Since the number N of components having a value of 1 in w is N=n₁₁+n₁₀, substituting n₁₁=N−n₁₀ obtained by modifying this formula into Formula (26) causes the Tanimoto similarity Sr to be expressed by Formula (27) described below.

$$\begin{matrix}[ Formula 27 ] & \\ {S}_{T} = \frac{N - {n}_{10}}{N - {n}_{10} + {n}_{10} + {n}_{01}} = \frac{N - {n}_{10}}{N + {n}_{01}} & ( 27 )\end{matrix}$$

Here, the constant C is introduced to define S_{RT} represented by Formula (28) described below.

$$\begin{matrix}[ Formula 28 ] & \\ {S}_{R T} = ( 1 - C ) {S}_{T} + C & ( 28 )\end{matrix}$$

S_{RT} in Formula (28) is hereinafter referred to as raised Tanimoto similarity. Here, Tanimoto similarities included in the two raised Tanimoto similarities are defined as S_{T}⁽¹⁾ and S_{T}⁽²⁾. At this time, the difference in raised Tanimoto similarity calculated from these is expressed by Formula (29) described below.

$$\begin{matrix}[ Formula 29 ] & \\ \{ ( 1 — C ) {S}_{T}^{( 1 )} + C \} - \{ ( 1 - C ) {S}_{T}^{( 2 )} + C \} = ( 1 - C ) ( {S}_{T}^{( 1 )} - {S}_{T}^{( 2 )} ) & ( 29 )\end{matrix}$$

From the above, it can be seen that the difference in raised Tanimoto similarity is a constant multiple of the difference in Tanimoto similarity. From this, it can be seen that when comparing the magnitude of the difference between the two sets, Tanimoto similarity and raised Tanimoto similarity can be similarly compared.

Tanimoto similarity is mathematically defined and widely applied similarity, and has shown effectiveness in various fields.

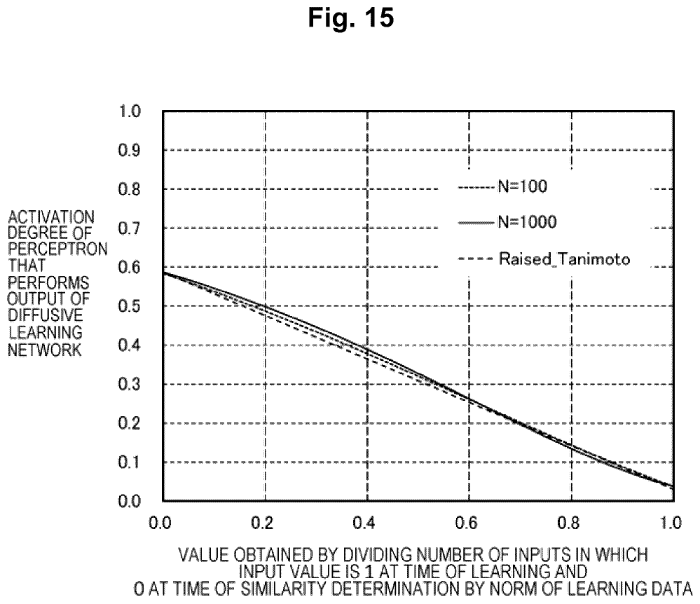

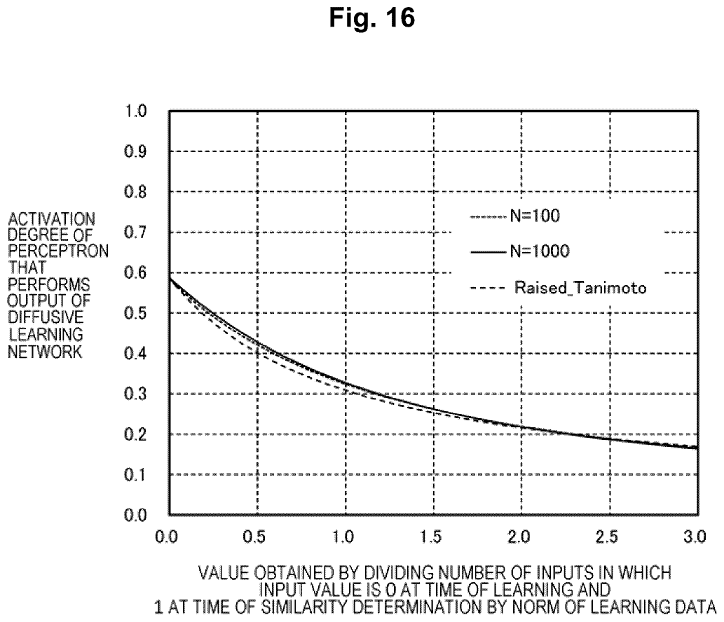

FIG. 15 is a diagram comparing an activation degree (output change when the number of inputs in which input value is 1 at the time of learning and 0 at the time of similarity determination is changed) of the perceptron that performs output of the diffusive information network and raised Tanimoto similarity when the divisive normalization similarity calculation method, the diffusive learning network, and the noise addition sensitivity characteristic improvement method are used. FIG. 16 is a diagram comparing an activation degree (output change when the number of inputs in which input value is 0 at the time of learning and 1 at the time of similarity determination is changed) of the perceptron that performs output of the diffusive information network and raised Tanimoto similarity when the divisive normalization similarity calculation method, the diffusive learning network, and the noise addition sensitivity characteristic improvement method are used.

In raised Tanimoto in FIGS. 15 and 16, the value of C in Formula (28) is 0.03. In FIGS. 15 and 16, raised Tanimoto similarity is represented by Raised-Tanimoto. In addition, for comparison, the value of raised Tanimoto similarity above is calculated with a coefficient (1−C) of Tanimoto similarity Sr included in Formula (28) as (D−C). Here, D represents the activation degree of the perceptron that performs output of the diffusive learning network when the horizontal axis is 0.

As can be seen from FIGS. 15 and 16, the gradient of the activation degree of the perceptron that performs output of the diffusive learning network is always a negative value, and (Note 1) can be solved. In addition, even when there is a different value of N as data at the time of learning, as can be seen from the fact that the activation degree of the perceptron that performs output of the diffusive learning network is a close value when N=100 or more, (Note 2) can be solved. Further, it can be seen that the activation degree of the perceptron that performs output of the diffusive learning network has a value close to raised Tanimoto similarity, and (Note 3) can be solved.

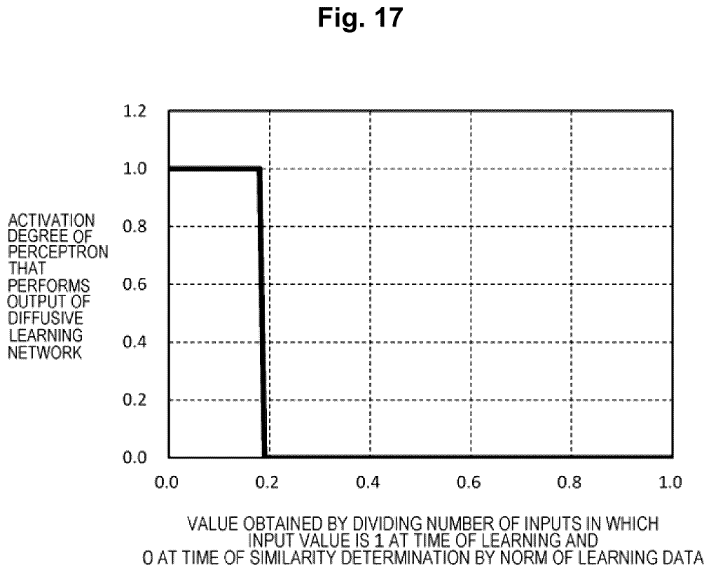

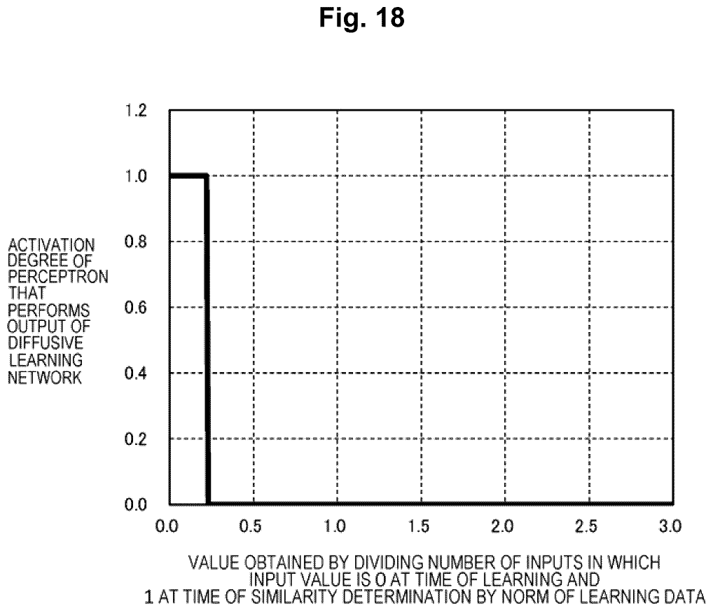

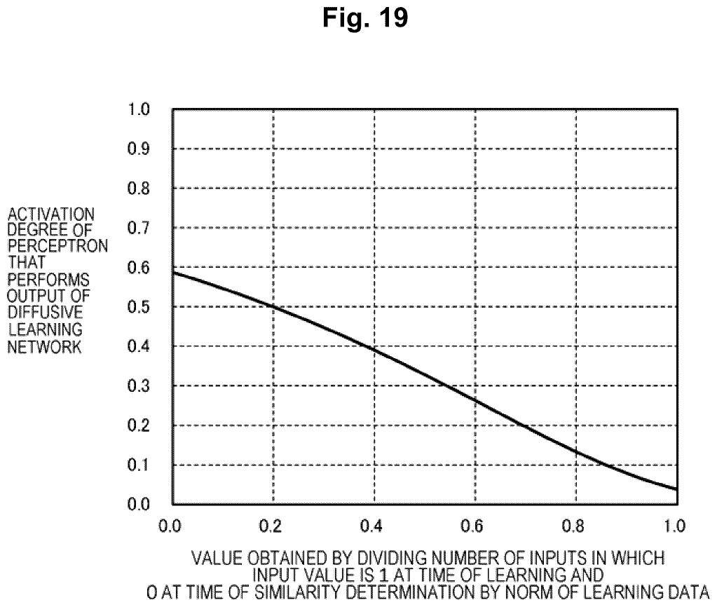

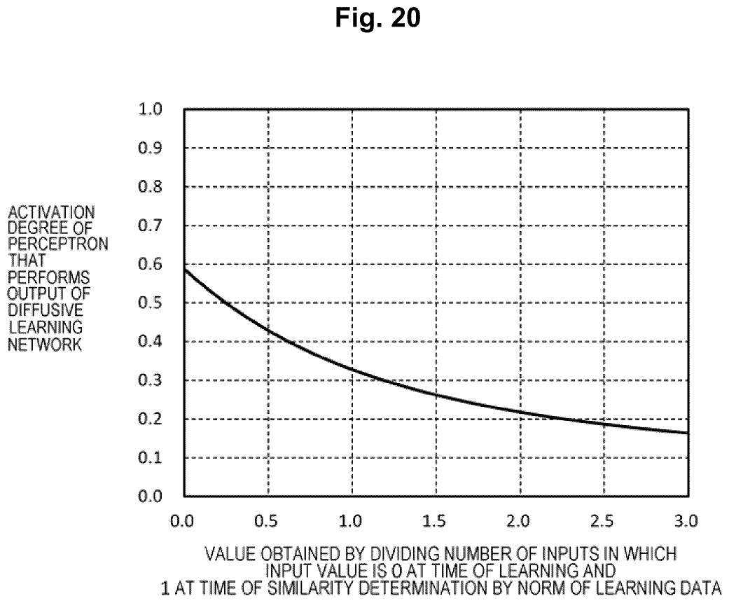

FIG. 17 is a diagram illustrating an output (when the number of inputs in which “input value is 1 at the time of learning and 0 at the time of similarity determination” is changed) of the perceptron when a sigmoid function is used as an activation function in divisive normalization similarity calculation. FIG. 18 is a diagram illustrating an output (when the number of inputs in which “input value is 0 at the time of learning and 1 at the time of similarity determination” is changed) of the perceptron when a sigmoid function is used as an activation function in divisive normalization similarity calculation. FIG. 19 is a diagram illustrating an expected value of an output (when the number of inputs in which “input value is 1 at the time of learning and 0 at the time of similarity determination” is changed) of the perceptron when the noise addition sensitivity characteristic improvement method is used. FIG. 20 is a diagram illustrating an expected value of an output (when the number of inputs in which “input value is 0 at the time of learning and 1 at the time of similarity determination” is changed) of the perceptron when the noise addition sensitivity characteristic improvement method is used.

Implementation examples of the fourth embodiment are <Example 1> and <Example 2>, and will be described in order.

### Example 1

<Example 1> is an example of processing of divisive normalization similarity determination of the fourth embodiment achieved by combining [divisive normalization similarity determination method] with [noise addition sensitivity characteristic improvement method].

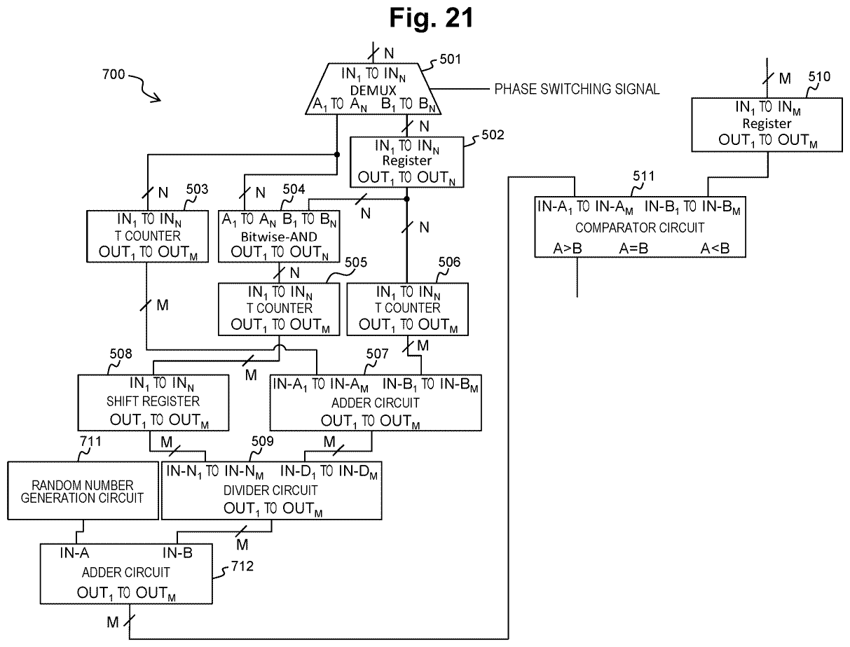

FIG. 21 is a diagram illustrating a neural network circuit device in a case where the divisive normalization similarity calculation and the noise addition sensitivity characteristic improvement method are combined in a case where an activation function is a step function for which any threshold can be set. In the description with reference to FIG. 21, the same components as those in FIG. 5 are denoted by the same reference signs, and redundant description will be omitted. In <Example 1>, a step function is used as an activation function.

<Example 1> is obtained by adding [noise addition sensitivity characteristic improvement method] to the first embodiment illustrated in FIG. 5. In a neural network circuit device 700 of FIG. 21, a random number generation circuit 711 and an adder circuit 712 are further added to the neural network circuit device 500 of FIG. 5.

The neural network circuit device 700 is a circuit combining the divisive normalization similarity calculation and the noise addition sensitivity characteristic improvement method.

The processing of the demultiplexer 501, the registers 502 and 510, the Bitwise-AND circuit 504, the T counter 503 (first counter), the T counter 505 (second counter), the T counter 506 (third counter), the adder circuit 507, the shift register 508, and the divider circuit 509 in FIG. 21 is as described in the first embodiment illustrated in FIG. 5. The divisive normalization similarity is output from the divider circuit 509.

The random number generation circuit 711 outputs a randomly selected number. As the randomly selected number, a random number according to a probability density function of Gaussian distribution can be used. However, the distribution is not limited, but a normal distribution, a Poisson distribution, a Weibull distribution, or other distributions may be used in addition to a Gaussian distribution. The random number generated by the random number generation circuit 711 is input to the adder circuit 712 together with the divisive normalization similarity output from the divider circuit 509. The sum of the divisive normalization similarity and the random number is output from the adder circuit 712. Subsequent processing of the comparator circuit 511 and the Register 510 is the same as that of the neural network circuit device 500 in FIG. 5, and the overall output is determined.

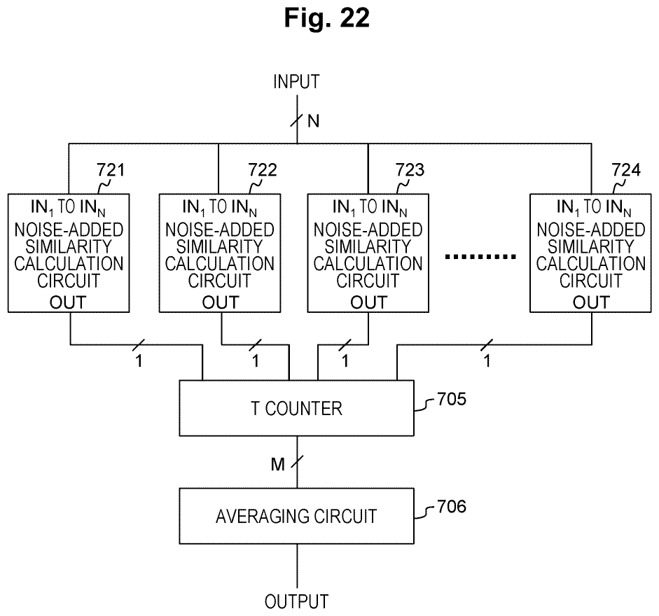

FIG. 22 is a parallel circuit in which a plurality of neural network circuit devices 700 in which the divisive normalization similarity calculation and the noise addition sensitivity characteristic improvement method of FIG. 21 are combined are connected.

FIG. 22 illustrates the neural network circuit device 700 illustrated in FIG. 21 as a noise-added similarity calculation circuit (721, 722, 723, and 724 in the drawing).

The input to the neural network circuit device 700 illustrated in FIG. 21 is transmitted to all the noise-added similarity calculation circuits 721, 722, 723, and 724. Then, each of the noise-added similarity calculation circuits 721, 722, 723, and 724 independently performs the processing of FIG. 21 described in the fourth embodiment in parallel. The outputs of all the noise-added similarity calculation circuits (721, 722, 723, and 724 in the drawing) are input to a T counter 705.

The T counter 705 calculates the number of inputs of 1, and outputs the number to an averaging circuit 706. The averaging circuit 706 outputs an averaged value obtained by dividing the input value by the number of noise-added similarity calculation circuits.

### Example 2

<Example 2> is an example of processing of divisive normalization similarity determination of the fourth embodiment achieved by combining [divisive normalization similarity determination method] with [noise addition sensitivity characteristic improvement method].

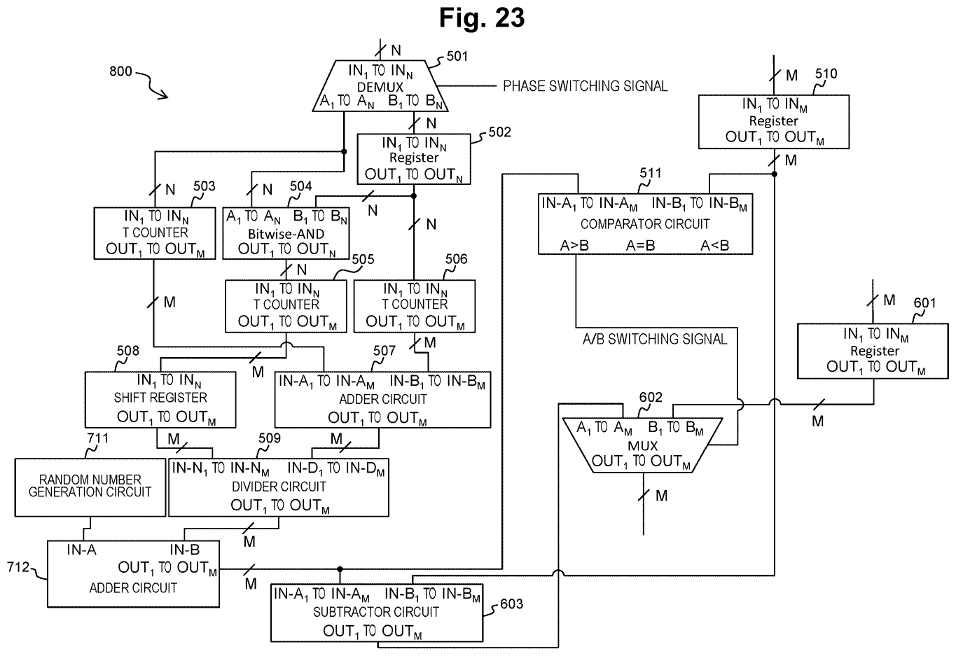

FIG. 23 is a diagram illustrating a neural network circuit device in a case where the divisive normalization similarity calculation and the noise addition sensitivity characteristic improvement method are combined in a case where an activation function is a linear function for which any threshold can be set. In the description with reference to FIG. 23, the same components as those in FIG. 8 are denoted by the same reference signs, and redundant description will be omitted. In <Example 2>, a linear function is used as an activation function.

<Example 2> is obtained by adding [noise addition sensitivity characteristic improvement method] to the first embodiment illustrated in FIG. 8. In a neural network circuit device 800 of FIG. 23, a random number generation circuit 711 and an adder circuit 712 are further added to the neural network circuit device 600 of FIG. 8.

The neural network circuit device 800 is a circuit combining the divisive normalization similarity calculation and the noise addition sensitivity characteristic improvement method.

The processing of the demultiplexer 501, the register 502, the Bitwise-AND circuit 504, the T counter 503 (first counter), the T counter 505 (second counter), the T counter 506 (third counter), the adder circuit 507, the shift register 508, and the divider circuit 509 in FIG. 23 is as described in the first embodiment illustrated in FIG. 8. The divisive normalization similarity is output from the divider circuit 509.

The random number generation circuit 711 outputs a randomly selected number. As the randomly selected number, a random number according to a probability density function of Gaussian distribution can be used. However, the distribution is not limited, but a normal distribution, a Poisson distribution, a Weibull distribution, or other distributions may be used in addition to a Gaussian distribution.

The random number generated by the random number generation circuit 711 is input to the adder circuit 712 together with the divisive normalization similarity output from the divider circuit 509. The sum of the divisive normalization similarity and the random number is output from the adder circuit 712. Subsequent processing of the comparator circuit 511 and the Registers 510 and 601, the subtractor circuit 603, and the multiplexer 602 is the same as that of the neural network circuit device 600 in FIG. 8, and the overall output is determined.

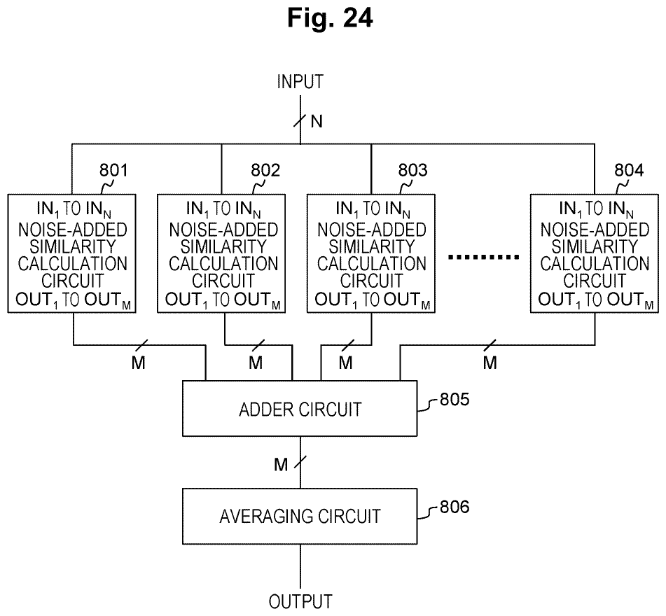

FIG. 24 is a parallel circuit in which a plurality of neural network circuit devices 800 in which the divisive normalization similarity calculation and the noise addition sensitivity characteristic improvement method of FIG. 23 are combined are connected.

FIG. 24 illustrates the neural network circuit device 800 illustrated in FIG. 23 as a noise-added similarity calculation circuit (801, 802, 803, and 804 in the drawing).

The input to the neural network circuit device 800 illustrated in FIG. 23 is transmitted to all the noise-added similarity calculation circuits 801, 802, 803, and 804. Then, each of the noise-added similarity calculation circuits 801, 802, 803, and 804 independently performs the processing of FIG. 23 described in the fourth embodiment in parallel. The outputs of all the noise-added similarity calculation circuits (801, 802, 803, and 804 in the drawing) are input to an adder circuit 805. The adder circuit 805 calculates the sum of the outputs of all the noise-added similarity calculation circuits, and outputs the sum to an averaging circuit 806. The averaging circuit 806 outputs an averaged value obtained by dividing the input value by the number of noise-added similarity calculation circuits.

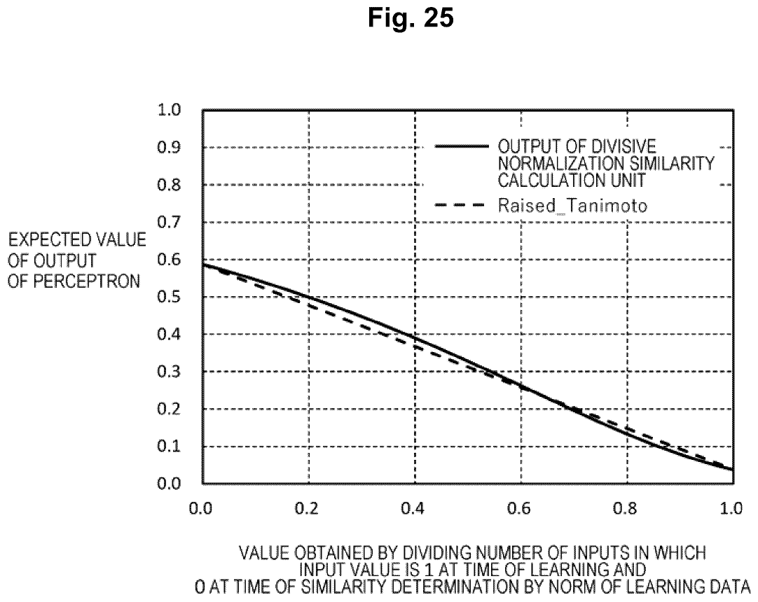

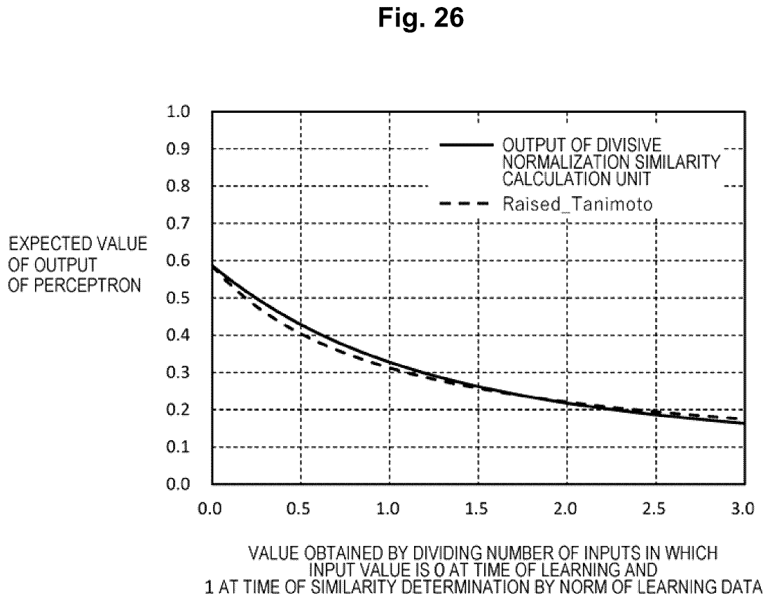

FIG. 25 is a diagram illustrating a comparison between an expected value of an output (output change when the number of inputs in which input value is 1 at the time of learning and 0 at the time of similarity determination is changed) of the perceptron and raised Tanimoto similarity when the divisive normalization similarity calculation method and the noise addition sensitivity characteristic improvement method are used. FIG. 26 is a diagram illustrating a comparison between an expected value of an output (output change when the number of inputs in which input value is 0 at the time of learning and 1 at the time of similarity determination is changed) of the perceptron and raised Tanimoto similarity when the divisive normalization similarity calculation method and the noise addition sensitivity characteristic improvement method are used.

As illustrated in FIGS. 25 and 26, it can be seen that the output of the divisive normalization similarity calculation unit (neural network circuit devices 700 and 800) can be approximated by Raised Tanimoto similarity.

### Effects of Fourth Embodiment

The neural network circuit devices 700 and 800 (FIGS. 21 and 23) according to the present embodiment further include the random number generation circuit 711 (FIGS. 21 and 23) that randomly generates a random number, and the second adder circuit (adder circuit 712) (FIGS. 21 and 23) that adds the random number generated by the random number generation circuit 711 to the output of the divider circuit 509 (FIGS. 21 and 23) as noise, and the comparator circuit (comparator circuit 511) (FIGS. 21 and 23) compares the output vector of the second adder circuit with a threshold vector.

In this way, in the neural network circuit devices 700 and 800, a circuit is achieved in which, in the similarity determination method (FIGS. 1 to 10) according to the first to third embodiments, similarity obtained by adding predetermined noise to the calculated similarity is obtained, and thereafter, calculation is performed using the similarity to which the noise is added. That is, in the fourth embodiment, a circuit is achieved in which, after the calculation of the similarity Sd represented by the processing of (1) the divisive normalization similarity calculation method and (2) the diffusive learning network method is performed, the similarity Sg to which the noise is added is obtained, and thereafter, the calculation is performed using Sg instead of Sd.

In a case where only (1) the divisive normalization similarity calculation method and (2) the diffusive learning network method of the first to third embodiments are used, a part having poor sensitivity for partially measuring similarity is generated (Note 1), it becomes difficult to compare the similarities with different learning data having different values of N (the number of inputs) (Note 2), and mathematically defined characteristics become unclear by performing the processing of (1) and (2) (Note 3).

In the fourth embodiment, by performing calculation using the similarity Sg to which noise is added, as can be seen by comparing FIGS. 11 and 13 and FIGS. 12 and 14, a part having poor sensitivity for partially measuring similarity has been eliminated (solution to Note 1). In addition, as illustrated in FIGS. 15 and 16, the activation degree of the perceptron that performs output of the diffusive learning network has a close value (solution to Note 2). Further, it can be seen that the activation degree of the perceptron that performs output of the diffusive learning network has a value close to raised Tanimoto similarity (solution to Note 3).

As a result, in the fourth embodiment, the similarity between the information stored in the learning phase and the information input to the similarity determination phase can be accurately measured by the divisive normalization similarity calculation method and the diffusive learning network. Eventually, it is possible to remove the difference in information and a discrepancy of the degree of similarity to be calculated in the prior art and to perform similarity calculation on the basis of the degree of similarity.

### Fifth Embodiment

A fifth embodiment is an application example of a divisive normalization similarity calculation method using Fuzzy logic.

In the first to third embodiments, Formula (6) described above and Formula (7) described above are used to calculate the similarity between the vector w=(w₁, w₂, w₃, . . . )^{T} representing the synaptic weight set by the input of the learning phase and the vector y=(y₁, y₂, y₃, . . . ) representing the input of the similarity determination phase. The use of Formula (30) described below has been described assuming that each component of the vectors w and y takes only a value of 0 or 1 in Formulas (6) and (7).

$$\begin{matrix}[ Formula 30 ] & \\ \frac{2 ( y \cdot w )}{{‖ w ‖}^{2} + {‖ y ‖}^{2}} = \frac{2 ( y \cdot w )}{{\sum }_{i} {w}_{i} + {\sum }_{i} {y}_{i}} & ( 30 )\end{matrix}$$

Here, (y·w) in Formula (30) represents an inner product and is Σᵢwᵢyᵢ. In the case of using this Formula (30), the value of the input can only take a value of 0 or 1. Thus, for example, it cannot be applied to a case where multistage values are handled instead of two stages of brightness and darkness such as brightness of an image, or an application range where stepless values such as real numbers are handled.

In order to solve this problem, from here, Fuzzy logic described in Non Patent Literature 9 is used as in Non Patent Literature 8 so that any real number from 0 to 1 can be taken as the value of the input. In this way, for example, when the value xᵢ of the input is in the range from the minimum value L to the maximum value H, the value xᵢ can be converted into a real number from 0 to 1 by replacing with (xᵢ−L)/(H−L), so that the above problem can be solved using Fuzzy logic.

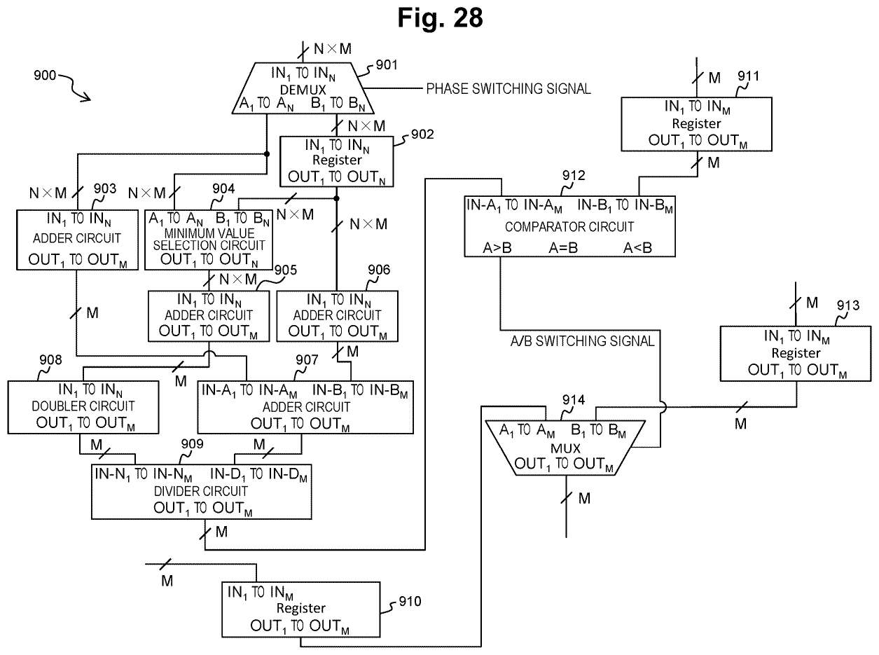

In the fifth embodiment, a minimum value selection circuit 904 (FIGS. 28 to 31) selects the minimum value for each component of the vector of the learning phase and the vector of the inference phase. Specifically, the minimum value selection circuit 904 performs a Fuzzy AND operation of extracting a minimum value component for each component of the vector. A vector output as a result of selecting the minimum value of each component by the Fuzzy AND operation is a logical product vector.

This replacement will be described.

0≤wᵢ≤1 and 0≤y₁≤1 are set, and for the component of the input x=(x₁, x₂, x₃, . . . )^{T} at the time of learning when w is determined, 0≤xᵢ≤1 is set, and Σᵢwᵢyᵢ is also rewritten as Σᵢwᵢ∧^{F}yᵢ. Here, ∧^{F} in wᵢ∧^{F}yᵢ is an operator, and a value of p∧^{F}q is a smaller value of p and q. More specifically, when p≥q, the value of p∧^{F}q is q. By this replacement, Formula (30) becomes Formula (31).

$$\begin{matrix}[ Formula 31 ] & \\ \frac{2 {\sum }_{i} {w}_{i} {Λ}^{F} {y}_{i}}{{\sum }_{i} {w}_{i} + {\sum }_{i} {y}_{i}} = \frac{2 {\sum }_{i} {z}_{i}}{{\sum }_{i} {w}_{i} + {\sum }_{i} {y}_{i}} & ( 31 )\end{matrix}$$

In Formula (31), zᵢ=wᵢ∧^{F}yᵢ.

With respect to the characteristic of Formula (31), a range of possible values of Formula (31), a condition that the value of Formula (31) becomes the maximum value, and a change in the value of Formula (31) when deviating from the condition that the value becomes the maximum value will be described.

First, a range of possible values of Formula (31) will be described.

Since a range of possible values of variables used in Formula (31) is 0≤wᵢ≤1, 0≤yᵢ≤1, and 0≤zᵢ≤1, Formula (31) does not take a negative value. In addition, for any i, the value of Formula (31) is 0 when zᵢ=0, and thus, it can be seen that the value of Formula (31) is 0 or more.

Next, when Formula (31) is used, the maximum value becomes 1 by Formula (32).

$$\begin{matrix}[ Formula 32 ] & \\ \frac{2 {\sum }_{i} {w}_{i} {Λ}^{F} {y}_{i}}{{\sum }_{i} {w}_{i} + {\sum }_{i} {y}_{i}} = \frac{2 {\sum }_{i} {z}_{i}}{{\sum }_{i} {w}_{i} + {\sum }_{i} {y}_{i}} ≦ \frac{2 {\sum }_{i} {z}_{i}}{{\sum }_{i} {z}_{i} + {\sum }_{i} {z}_{i}} = \frac{2 {\sum }_{i} {z}_{i}}{2 {\sum }_{i} {z}_{i}} = 1 & ( 32 )\end{matrix}$$

From the above discussion, it can be seen that the value of Formula (31) is 0 or more and 1 or less. Secondly, the condition that the value of Formula (31) becomes the maximum value will be described. Since the maximum value of the value of Formula (31) is 1, Conditional Formula (33) described below is obtained.

$$\begin{matrix}[ Formula 33 ] & \\ \frac{2 {\sum }_{i} {w}_{i} {Λ}^{F} {y}_{i}}{{\sum }_{i} {w}_{i} + {\sum }_{i} {y}_{i}} = \frac{2 {\sum }_{i} {z}_{i}}{{\sum }_{i} {w}_{i} + {\sum }_{i} {y}_{i}} = 1 & ( 33 )\end{matrix}$$

When this is modified, Formula (34) is obtained.

$$\begin{matrix}[ Formula 34 ] & \\ 2 {\sum }_{i} {z}_{i} = {\sum }_{i} {w}_{i} + {\sum }_{i} {y}_{i} & ( 34 )\end{matrix}$$

Further modification gives Formula (35) described below.

$$\begin{matrix}[ Formula 35 ] & \\ {\sum }_{i} ( {w}_{i} - {z}_{i} ) + {\sum }_{i} ( {y}_{i} - {z}_{i} ) = 0 & ( 35 )\end{matrix}$$

In Formula (35), since wᵢ−zᵢ≥0 and yᵢ−zᵢ≥0, the condition that satisfies Formula (35) is wᵢ=zᵢ and yᵢ=zᵢ for arbitrary i.

Thus, since wᵢ=yᵢ=zᵢ, the condition that the value of Formula (31) takes the maximum value is when wᵢ=yᵢ for arbitrary i.

Thirdly, a change in the value of Formula (31) when deviating from the condition that the value of Formula (31) becomes the maximum value will be described.

In Formula (31), wᵢ is determined in the learning phase, and is a constant in the similarity determination phase. Therefore, partial differentiation is performed on Formula (31) by yₖ as in Formula (36).

$$\begin{matrix}[ Formula 36 ] & \\ \frac{\partial }{\partial {y}_{k}} \frac{2 {\sum }_{i} {z}_{i}}{{\sum }_{i} {w}_{i} + {\sum }_{i} {y}_{i}} = \frac{\partial }{\partial {y}_{k}} \frac{2 ( {\sum }_{i \neq k} {z}_{í} + {z}_{k} )}{{\sum }_{i} {w}_{i} + {\sum }_{i \neq k} {y}_{i} + {y}_{k}} & ( 36 )\end{matrix}$$

First, considering the case of wₖ<yₖ, zₖ wₖ holds. Then, Formula (36) becomes Formula (37) described below.

$$\begin{matrix}[ Formula 37 ] & \\ \frac{\partial }{\partial {y}_{k}} \frac{2 ( {\sum }_{i \neq k} {z}_{i} + {w}_{k} )}{{\sum }_{i} {w}_{i} + {\sum }_{i \neq k} {y}_{i} + {y}_{k}} = \frac{- 2 ( {\sum }_{i \neq k} {z}_{i} + {w}_{k} )}{{( {\sum }_{i} {w}_{i} + {\sum }_{i \neq k} {y}_{i} + {y}_{k} )}^{2}} & ( 37 )\end{matrix}$$

Here, when all of wᵢ and yᵢ are not 0, the denominator of the above formula is obviously a positive value, and the numerator of Formula (37) is obviously a negative value. From this, it can be seen that, in the range of wₖ<yₖ, the value of Formula (31) monotonically decreases with respect to an increase in yₖ.

Next, considering the case of wₖ≥yₖ, zₖ=yₖ holds. Then, Formula (37) becomes Formula (38) described below.

$$\begin{matrix}[ Formula 38 ] & \\ \frac{\partial }{\partial {y}_{k}} \frac{2 ( {\sum }_{i \neq j} {z}_{i} + {y}_{k} )}{{\sum }_{i} {w}_{i} + {\sum }_{i \neq k} + {y}_{k}} = \frac{2 \{ ( {\sum }_{i} {w}_{i} + {\sum }_{i \neq k} {y}_{i} + {y}_{k} ) - ( {\sum }_{i \neq k} {z}_{i} + {y}_{k} ) \}}{{( {\sum }_{i} {w}_{i} + {\sum }_{i \neq k} {y}_{i} + {y}_{k} )}^{2}} = \frac{2 \{ ( {\sum }_{i \neq k} {w}_{i} + {w}_{k} + {\sum }_{i \neq k} {y}_{i} + {y}_{k} ) - ( {\sum }_{i \neq k} {z}_{i} + {y}_{k} ) \}}{{( {\sum }_{i} {w}_{i} + {\sum }_{i \neq k} {y}_{i} + {y}_{k} )}^{2}} = \frac{2 \{ {\sum }_{i \neq k} ( {w}_{i} + {w}_{k} - {z}_{i} ) + {w}_{k} \}}{{( {\sum }_{i} {w}_{i} + {\sum }_{i \neq k} {y}_{i} + {y}_{k} )}^{2}} ≧ \frac{2 \{ {\sum }_{i \neq k} ( 2 {z}_{i} - {z}_{i} ) + {w}_{k} \}}{{( {\sum }_{i} {w}_{i} + {\sum }_{i \neq k} {y}_{i} + {y}_{k} )}^{2}} = \frac{2 ( {\sum }_{i \neq k} {z}_{i} + {w}_{k} )}{{( {\sum }_{i} {w}_{i} + {\sum }_{i \neq k} {y}_{i} + {y}_{k} )}^{2}} & ( 38 )\end{matrix}$$

Here, when all of wₖ and yₖ are not 0, the denominator of Formula (38) is obviously a positive value, and the numerator of Formula (38) is also obviously a positive value. From this, it can be seen that, in the range of wₖ≥yₖ, the value of Formula (31) monotonically increases with respect to an increase in yₖ. From the above discussion, it can be seen that when deviating from the condition that the value of Formula (31) becomes the maximum value, the value of Formula (31) behaves as monotonically decreasing as deviating.

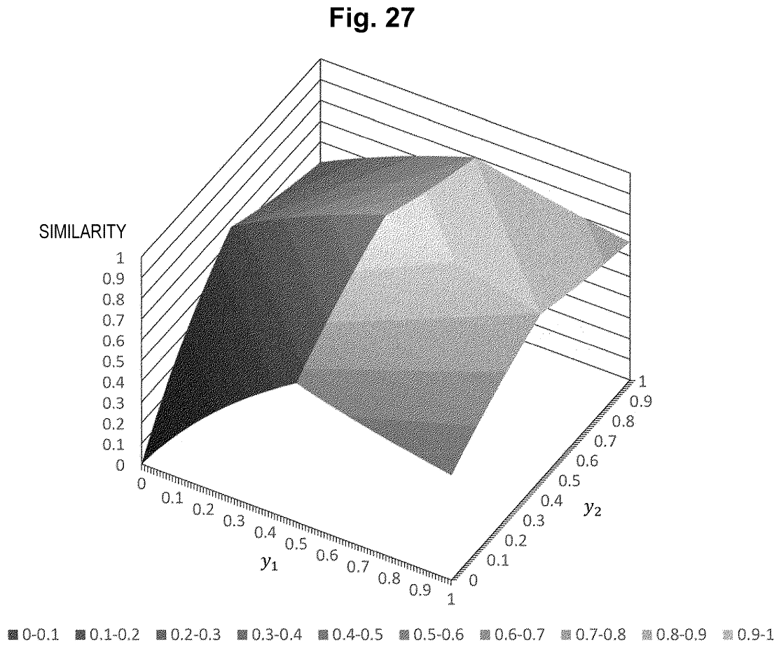

FIG. 27 is a diagram for describing an example of similarity by the divisive normalization similarity calculation method using Fuzzy logic. FIG. 27 illustrates a change in similarity when y=(y₁, y₂) is changed when w=(w₁, w₂)=(0.5, 0.5). In other words, it is a similarity calculation result when replaced with Fuzzy logic when w=(w₁, w₂)=(0.5, 0.5).

In FIG. 27, y=(y₁, y₂) is changed. In addition, the similarity in FIG. 27 is calculated based on Formula (31). As can be seen from FIG. 27, it can be seen that the similarity decreases as y=(y₁, y₂) deviates from y=(0.5, 0.5).

Here, in the case of not using Fuzzy logic, it has been described using Formulas (9) and (10) that the similarity represented by Formula (7) decreases as the change of the vector y from the vector w increases. In the above description, the change of the vector y from the vector w means a change of each element yᵢ from wᵢ. That is, it is the change of the element from 0 to 1 and the change from 1 to 0, and it has been described as the change in similarity when no and n₀₁ increase accordingly. When Fuzzy logic is used, each element continuously changes, and thus, using partial differentiation, a change in the calculated similarity with respect to a change of each element yᵢ from wᵢ is described by Formulas (37) and (38), and a change in the numerical similarity is described with reference to FIG. 27.

From the above, it can be seen that the formula for calculating the similarity can be replaced with Formula (31) since what has been described here is the same characteristic as when the similarity is calculated by Formulas (6) and (7).

Implementation examples of the fifth embodiment are <Example 3>, <Example 4>, <Example 5>, and <Example 6>, and will be described in order.

### Example 3

An implementation method using a logic circuit regarding a divisive normalization similarity calculation method of the fifth embodiment will be described. <Example 3> is an example in a case where Fuzzy logic is used.

FIG. 28 is a diagram illustrating a neural network circuit device that achieves divisive normalization similarity calculation using Fuzzy logic in a case where an activation function is a step function for which any threshold can be set. FIG. 28 illustrates a case where an activation function is a step function for which any threshold can be set in the divisive normalization similarity calculation method using Fuzzy logic.

As illustrated in FIG. 28, a neural network circuit device 900 includes a demultiplexer (DEMUX) 901, registers (Register) 902, 910, 911, and 913, adder circuits 903, 905, 906, and 907, a minimum value selection circuit 904, a doubler circuit 908, a divider circuit 909, a comparator circuit 912, and a multiplexer (MUX) 914.

### [Operation]

The operation of the neural network circuit device 900 configured as described above will be described below.

### <Learning Phase>

First, the input vector x=(x₁, x₂, . . . , X_{N})^{T} in the learning phase is received by the demultiplexer 901. The demultiplexer 901 outputs the input signal to one of the outputs A₁ to A_{N} and B₁ to B_{N}. To which one to output is designated by the phase switching signal S input to the demultiplexer 901. The phase switching signal S is a signal for distinguishing the learning phase and the similarity determination phase. When this signal is the value of the signal indicating the learning phase, the input vector x is transmitted from the outputs B₁ to B_{N} to the register 902. At this time, the register 902 stores the value of the input vector x and outputs the value from OUT₁ to OUT_{N}.

In <Example 3>, since the synaptic weight is determined as w=x, x stored in the register 902 is set as W=(w₁, w₂, . . . , w_{N})^{T}. The output of the register 902 is transmitted to the minimum value selection circuit 904 and the adder circuit 906. The minimum value selection circuit 904 compares Aᵢ and Bᵢ for all i regarding the two inputs A₁ to A_{N} and B₁ to B_{N}, and outputs the minimum values of both. The adder circuits 903, 905, and 906 calculate the total sum of the values input to the inputs IN₁ to IN_{N}, and outputs the values from OUT₁ to OUT_{M}.

The adder circuit 906 calculates Σᵢwᵢ included in Formula (31) for the synaptic weight w.

### <Similarity Determination Phase>

Next, in the similarity determination phase, an input vector y is input to the demultiplexer 901, and the input vector y is output to A₁ to A_{N} on the basis of the phase switching signal. This output is sent to the adder circuit 903 and the minimum value selection circuit 904. The adder circuit 903 calculates Σᵢyᵢ included in Formula (31) from the input y by the same operation as the adder circuit 906.

The synaptic weight w and the input vector y of the similarity determination phase are input to the minimum value selection circuit 904, and wᵢ∧^{F}yᵢ is calculated. This result is input to the adder circuit 905. The adder circuit 905 outputs Σᵢwᵢ∧^{F}yᵢ included in Formula (31). The result of the adder circuit 905 is further sent to the doubler circuit 908, and a value that is twice the result of the adder circuit 905 is output. This value becomes the value 2Σᵢwᵢ∧^{F}yᵢ of the numerator of Formula (31).

Outputs of the adder circuit 903 and the adder circuit 906 are Σᵢyᵢ and Σᵢwᵢ, respectively, and are sent to the adder circuit 907. The adder circuit 907 calculates and outputs the denominator Σᵢwᵢ+Σᵢyᵢ of Formula (31). The divider circuit 909 receives input values 2Σwᵢ∧^{F}yᵢ and Σᵢwᵢ+Σᵢyᵢ from the doubler circuit 908 and the adder circuit 907, respectively. Then, the divider circuit 909 performs a division operation of dividing 2Σᵢwᵢ∧^{F}yᵢ by Σᵢwᵢ+Σᵢyᵢ.

Through the above processing, the divider circuit 909 calculates the similarity and outputs the result.

The register 911 stores the value by inputting the threshold of the activation function in advance. As a result, the calculated similarity and threshold are sent to inputs IN-A₁ to IN-A_{M} and IN-B₁ to IN-B_{M} and compared with each other in the comparator circuit 912. The output A>B is 1 when the values input to IN-A₁ to IN-A_{M} are larger than the values input to IN-B₁ to IN-B_{M} as the comparison result, the output A=B is 1 when the values are equal, and the output A<B is 1 when the values input to IN-A₁ to IN-A_{M} are smaller than the values input to IN-B₁ to IN-B_{M}.

The register 910 and the register 913 store in advance the value of the output when the similarity exceeds the threshold of the activation function and the value of the output when the similarity does not exceed the threshold of the activation function.

According to the result of the comparator circuit 912, when the output value of the divider circuit 909 exceeds the value stored in the register 911, the value stored in the register 910 becomes the output of the multiplexer 914, and otherwise, the value stored in the register 913 becomes the output of the multiplexer 914.

### Example 4

An implementation method using a logic circuit regarding a divisive normalization similarity calculation method of the fifth embodiment will be described. <Example 4> is an example in a case where Fuzzy logic is used.

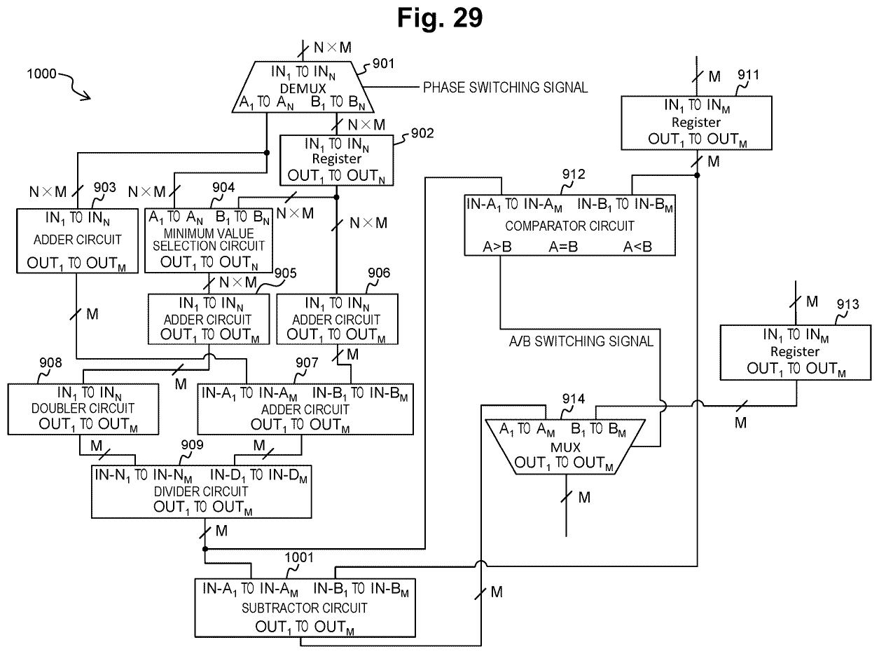

FIG. 29 is a diagram illustrating a neural network circuit device that achieves divisive normalization similarity calculation using Fuzzy logic in a case where an activation function is a linear function for which any threshold can be set. FIG. 29 illustrates a case where an activation function is a linear function for which any threshold can be set in the divisive normalization similarity calculation method using Fuzzy logic.

As illustrated in FIG. 29, a neural network circuit device 1000 includes a demultiplexer (DEMUX) 901, registers (Register) 902, 911, and 913, adder circuits 903, 905, 906, and 907, a minimum value selection circuit 904, a doubler circuit 908, a divider circuit 909, a subtractor circuit 1001, a comparator circuit 912, and a multiplexer (MUX) 914.

That is, the neural network circuit device 1000 includes the subtractor circuit 1001 that subtracts the value (threshold of input) of the register 911 from the output of the divider circuit 909 instead of the register 910 of the neural network circuit device 900 illustrated in FIG. 28.

### [Operation]

The operation of the neural network circuit device 1000 configured as described above will be described below. The input is input to the demultiplexer 901. The operation from the input to the output of the divider circuit 909 is the same as that from the demultiplexer 901 to the output of the divider circuit 909 of the neural network circuit device 900 in FIG. 28. The output of the divider circuit 909 represents similarity.

The output of the divider circuit 909 is sent to the subtractor circuit 1001 and the comparator circuit 912. In addition to the subtractor circuit 1001, the comparator circuit 912 receives an input from the register 911. The register 911 stores a threshold of the activation function. The threshold is input in advance, and the register 911 outputs the stored threshold.

Inputs from the subtractor circuit 1001 and the register 911 are received by IN-A₁ to IN-A_{M} and IN-B₁ to IN-B_{M} of the comparator circuit 912, respectively. The comparator circuit 912 compares the threshold (stored in the register 911) of the activation function with the divider circuit 909. Then, in the comparator circuit 912, the output A>B is 1 when the values input to IN-A₁ to IN-A_{M} are larger than the values input to IN-B₁ to IN-B_{M} as the comparison result, the output A=B is 1 when the values are equal, and the output A<B is 1 when the values input to IN-A₁ to IN-A_{M} are smaller than the values input to IN-B₁ to IN-B_{M}.

The output A>B of the comparator circuit 912 is connected to the multiplexer 914, and one of the two systems of the inputs A₁ to A_{M} and B₁ to B_{M} is output from the outputs OUT₁ to OUT_{M}. The value of the output A>B is input to the multiplexer, and which one of the two systems to output is switched according to the value. When this value is 1, A to A_{M} are output to OUT₁ to OUT_{M}, and when this value is 0, B₁ to B_{M} are output to OUT₁ to OUT_{M}. The outputs of the subtractor circuit 1001 are connected to the inputs A₁ to A_{M} of the multiplexer 914. The divider circuit 909 calculates the similarity by a division operation of dividing the output 2Σᵢwᵢ∧^{F}yᵢ of the doubler circuit 908 by the output Σᵢwᵢ+Σᵢyᵢ of the adder circuit 907.

The value of the divider circuit 909 is sent to the inputs IN-A₁ to IN-A_{M} of the subtractor circuit 1001. In addition, the threshold stored in the register 911 is input to the inputs IN-B₁ to IN-B_{M} of the subtractor circuit 1001. As a result, the output of the subtractor circuit 1001 becomes a value obtained by subtracting the threshold from the similarity, and this value is sent to the multiplexer 914. The value stored in the register 913 is sent to the inputs B₁ to B_{M} of the multiplexer 914. The register 913 stores an output value when the similarity is equal to or less than the threshold in advance. When the linear function is used as the activation function, the value 0 is stored in the register 913.

### Example 5

An implementation method using a logic circuit regarding a divisive normalization similarity calculation method of the fifth embodiment will be described. <Example 5> is an example of a case where the divisive normalization similarity calculation method and the noise addition sensitivity characteristic improvement method are combined, and for the divisive normalization similarity calculation method, the divisive normalization similarity calculation method by Fuzzy logic is used.

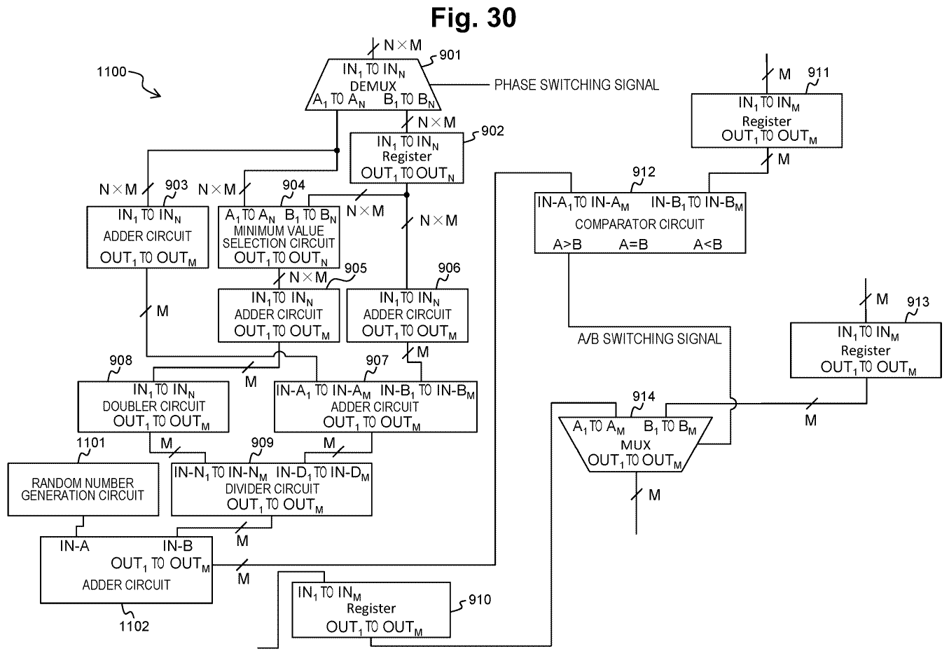

FIG. 30 is a diagram illustrating a neural network circuit device in a case where the divisive normalization similarity calculation using Fuzzy logic and the noise addition sensitivity characteristic improvement method are combined in a case where an activation function is a step function for which any threshold can be set. In <Example 5>, a step function is used as an activation function.

<Example 5> is obtained by adding the noise addition sensitivity characteristic improvement method to <Example 3>, and a circuit configuration (implementation example) is illustrated in FIG. 30.

As illustrated in FIG. 30, a neural network circuit device 1100 includes a random number generation circuit 1101 and an adder circuit 1102 in addition to the neural network circuit device 900 of FIG. 28.

### [Operation]

The operation of the neural network circuit device 1100 configured as described above will be described below. The processing from the demultiplexer (DEMUX) 901 to the divider circuit 909 of the neural network circuit device 1100 illustrated in FIG. 30 is as described with reference to FIG. 28. The divisive normalization similarity by Fuzzy logic is output from the divider circuit 909 by the processing from the demultiplexer (DEMUX) 901 to the divider circuit 909 in FIG. 30.

The random number generation circuit 1101 outputs a randomly selected number. As the randomly selected number, a random number according to a probability density function of Gaussian distribution can be used. However, the distribution is not limited, but a normal distribution, a Poisson distribution, a Weibull distribution, or other distributions may be used in addition to a Gaussian distribution. The random number generated by the random number generation circuit 1101 is input to the adder circuit 1102 together with the divisive normalization similarity output from the divider circuit 909. The sum of the divisive normalization similarity by Fuzzy logic and the random number is output from the adder circuit 1102. The output of the adder circuit 1102 is input to the comparator circuit 912. Subsequent processing of the comparator circuit 912, the Registers 910, 911, and 913, and the multiplexer 914 is the same as that in FIG. 28, and the overall output is determined.

Here, in FIG. 24 of <Example 2> described above, an example in which a plurality of FIG. 23 is connected has been described. Also in <Example 5>, as in the case of <Example 2>, FIG. 30 can be used as the noise-added similarity calculation circuits (801, 802, 803, and 804) of FIG. 24. In this case, <Example 5> can obtain an output obtained by averaging the outputs of a circuit obtained by combining the divisive normalization similarities by Fuzzy logic and the noise addition sensitivity characteristic improvement methods by the same processing as that described in <Example 4>.

### Example 6

An implementation method using a logic circuit regarding a divisive normalization similarity calculation method of the fifth embodiment will be described. <Example 6> is an example of a case where the divisive normalization similarity calculation method and the noise addition sensitivity characteristic improvement method are combined, and for the divisive normalization similarity calculation method, the divisive normalization similarity calculation method by Fuzzy logic is used.

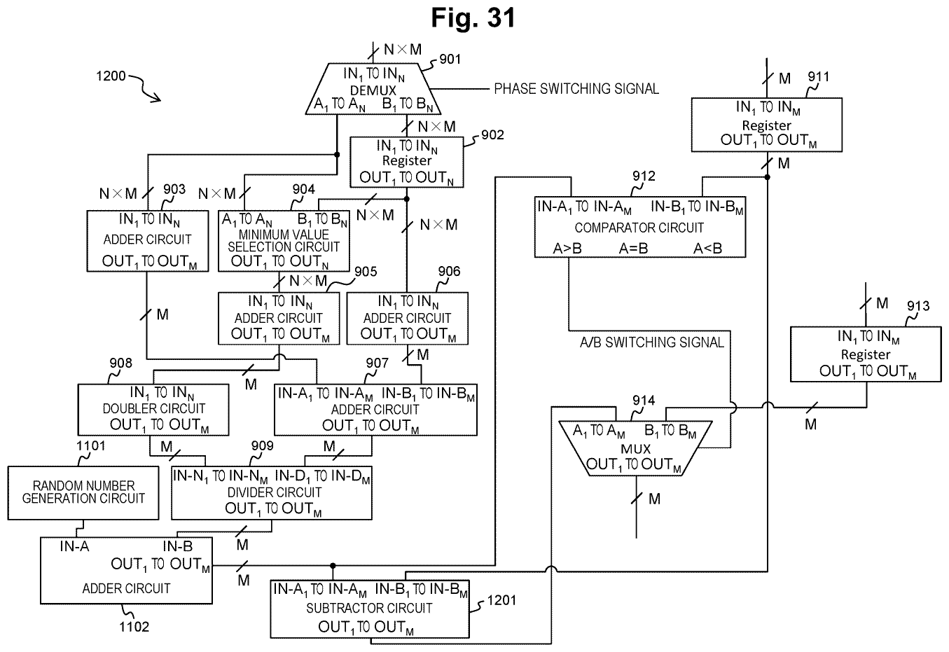

FIG. 31 is a diagram illustrating a neural network circuit device in a case where the divisive normalization similarity calculation using Fuzzy logic and the noise addition sensitivity characteristic improvement method are combined in a case where an activation function is a linear function for which any threshold can be set. In <Example 6>, a linear function is used as an activation function. <Example 6> is obtained by adding the noise addition sensitivity characteristic improvement method to <Example 4>, and a circuit configuration (implementation example) is illustrated in FIG. 31.

As illustrated in FIG. 31, a neural network circuit device 1200 includes a random number generation circuit 1101 and an adder circuit 1102 in addition to the neural network circuit device 1000 of FIG. 29, and the subtractor circuit 1001 of the neural network circuit device 1000 of FIG. 29 is replaced with a subtractor circuit 1201 of FIG. 31.

### [Operation]

The operation of the neural network circuit device 1200 configured as described above will be described below. The processing from the demultiplexer (DEMUX) 901 to the divider circuit 909 of the neural network circuit device 1200 illustrated in FIG. 31 is as described with reference to FIG. 28. The divisive normalization similarity by Fuzzy logic is output from the divider circuit 909 by the processing from the demultiplexer (DEMUX) 901 to the divider circuit 909 in FIG. 31.

The random number generation circuit 1101 outputs a randomly selected number. As the randomly selected number, a random number according to a probability density function of Gaussian distribution can be used. However, the distribution is not limited, but a normal distribution, a Poisson distribution, a Weibull distribution, or other distributions may be used in addition to a Gaussian distribution. The random number generated by the random number generation circuit 1101 is input to the adder circuit 1102 together with the divisive normalization similarity output from the divider circuit 909. The sum of the divisive normalization similarity by Fuzzy logic and the random number is output from the adder circuit 1102.

The value of the adder circuit 1102 is sent to the inputs IN-A₁ to IN-A_{M} of the subtractor circuit 1201. In addition, the threshold stored in the register 911 is input to the inputs IN-B₁ to IN-B_{M} of the subtractor circuit 1201. As a result, the output of the subtractor circuit 1201 becomes a value obtained by subtracting the threshold from the similarity, and this value is sent to the multiplexer 914. The value stored in the register 913 is sent to the inputs B₁ to B_{M} of the multiplexer 914. The register 913 stores an output value when the similarity is equal to or less than the threshold in advance. When the linear function is used as the activation function, the value 0 is stored in the register 913.

Here, in FIG. 24 of <Example 2> described above, an example in which a plurality of FIG. 23 is connected has been described. Also in <Example 6>, as in the case of <Example 2>, FIG. 31 can be used as the noise-added similarity calculation circuits (801, 802, 803, and 804) of FIG. 24. In this case, <Example 6> can obtain an output obtained by averaging the outputs of a circuit obtained by combining the divisive normalization similarities by Fuzzy logic and the noise addition sensitivity characteristic improvement methods by the same processing as that described in <Example 4>.

### Effects of Fifth Embodiment

As described above, the neural network circuit devices 900, 1000, 1100, and 1200 (FIGS. 28 to 31) that calculate the degree of similarity between the input of the learning phase and the input of the inference phase using the perceptron obtained by modeling a nerve cell include the second adder circuit (adder circuit 903) that adds for each component of the vector of the inference phase, the minimum value selection circuit 904 (FIGS. 28 to 31) that selects the minimum value for each component of the vector of the learning phase and the vector of the inference phase, the third adder circuit (adder circuit 905) (FIGS. 28 to 31) that adds for each component of the Fuzzy AND vector obtained by the Fuzzy AND operation using the Fuzzy AND operation of extracting the minimum value component for each component of the vector in the minimum value selection circuit 904, the fourth adder circuit (adder circuit 906) (FIGS. 28 to 31) that adds the component of the input vector at the time of the learning phase, the fifth adder circuit (adder circuit 907) (FIGS. 28 to 31) that adds the outputs of the second adder circuit (adder circuit 903) and the fourth adder circuit (adder circuit 906), the doubler circuit 908 (FIGS. 28 to 31) that doubles the output of the third adder circuit (adder circuit 905), and the divider circuit 909 (FIGS. 28 to 31) that divides the output value of the doubler circuit 908 by the output value of the fifth adder circuit (adder circuit 907).

In this way, in the neural network circuit devices 900, 1000, 1100, and 1200, circuits that perform replacement with a value that can take any real numbers from 0 to 1 by using Fuzzy logic in the similarity determination method (FIGS. 1 to 10) according to the first to third embodiments are achieved. In this way, it can be applied to a case where the value of the input is not only a value of 0 or 1, for example, multistage values are handled instead of two stages of brightness and darkness such as brightness of an image, or an application range where stepless values such as real numbers are handled.

The present invention is not limited to the above-described exemplary embodiments, and includes other modifications and application examples without departing from the gist of the present invention described in the claims.

In addition, the above-described exemplary embodiments have been described in detail for easy description of the present invention, and are not necessarily limited to those having all the described configurations. In addition, a part of a certain configuration of the exemplary embodiment can be replaced with another configuration of the exemplary embodiment, and another configuration of the exemplary embodiment can be added to the certain configuration of the exemplary embodiment. In addition, the exemplary embodiments can be implemented in various other forms, and various omissions, substitutions, and changes can be made without departing from the gist of the invention. These embodiments and modifications thereof are included in the scope and gist of the invention, and are included in the invention described in the claims and the equivalent scope thereof.

In addition, among the processing described in each of the above embodiments, all or part of the processing described as being automatically performed can be manually performed, or all or part of the processing described as being manually performed can be automatically performed by a known method. In addition to this, information including the processing procedures, the control procedures, the specific names, the various kinds of data, and the parameters mentioned above in the specification or shown in the drawings can be modified as desired, unless otherwise particularly specified.

In addition, each component of each device that has been illustrated is functionally conceptual, and is not necessarily physically configured as illustrated. That is, a specific form of distribution and integration of each device is not limited to the illustrated form, and all or a part thereof can be functionally or physically distributed and integrated in any unit according to various loads, usage conditions, and the like.

In addition, some or all of the above-described configurations, functions, processing units, processing means, and the like may be implemented by hardware, for example, by designing with an integrated circuit. In addition, each of the above-described configurations, functions, and the like may be implemented by software for interpreting and performing a program for the processor to implement each function. Information such as a program, a table, and a file for implementing the functions can be held in a recording device such as memory, a hard disk, or a solid state drive (SSD), or in a recording medium such as an integrated circuit (IC) card, a secure digital (SD) card, or an optical disc.

In addition, in each of the embodiments described above, the name of the neural network circuit device is used, but this is for convenience of description, and the name may be divisive normalization similarity calculation unit, similarity calculation unit circuit device, or the like.

1. A neural network circuit device that calculates a degree of similarity between an input of a learning phase and an input of an inference phase using a perceptron obtained by modeling a nerve cell, the neural network circuit device comprising:
a logical conjunction operation circuit that calculates a logical product between a vector of the learning phase and a vector of the inference phase;
a first counter that counts a number of inputs of input vectors having a value of 1 at a time of the inference phase;
a second counter that counts a number of inputs of logical product vectors having a value of 1 obtained by a logical conjunction operation by the logical conjunction operation circuit;
a third counter that counts a number of inputs of vectors having a value of 1 at a time of the learning phase;
an adder circuit that adds an output of the first counter and an output of the third counter;
a shift register that shifts a result of the second counter to a high-order side by 1 bit; and
a divider circuit that divides an output vector of the shift register by an output vector of the adder circuit.

2. A neural network circuit device that calculates a degree of similarity between an input of a learning phase and an input of an inference phase using a perceptron obtained by modeling a nerve cell, the neural network circuit device comprising:
a second adder circuit that adds for each component of a vector of the inference phase;
a minimum value selection circuit that selects a minimum value for each component of a vector of the learning phase and the vector of the inference phase;
a third adder circuit that adds for each component of a Fuzzy AND vector obtained by a Fuzzy AND operation using the Fuzzy AND operation of extracting a minimum value component for each component of the vector in the minimum value selection circuit;
a fourth adder circuit that adds a component of an input vector at a time of the learning phase;
a fifth adder circuit that adds outputs of the second adder circuit and the fourth adder circuit;
a doubler circuit that doubles an output of the third adder circuit; and
a divider circuit that divides an output value of the doubler circuit by an output value of the fifth adder circuit.

3. The neural network circuit device according to claim 1, comprising:
a demultiplexer that receives an input vector in the learning phase and outputs an input signal of the input vector to one of a first output and a second output designated by a phase switching signal.

4. The neural network circuit device according to claim 1,
wherein
the divider circuit includes
a storage that stores a reciprocal of a divisor, and
a multiplier circuit that multiplies the reciprocal of the divisor read when the divisor is given to the storage by a dividend.

5. The neural network circuit device according to claim 1, further comprising:
a comparator circuit that compares an output vector of the divider circuit with a threshold vector.

6. The neural network circuit device according to claim 1, comprising:
a subtractor circuit that subtracts a threshold from an output vector of the divider circuit; and
a multiplexer that switches and outputs an output vector of the subtractor circuit and a predetermined value according to an output of the comparator circuit.

7. The neural network circuit device according to claim 5, further comprising:
a random number generation circuit that randomly generates a random number; and
a sixth adder circuit that adds the random number generated by the random number generation circuit to an output of the divider circuit as noise, wherein
the comparator circuit compares an output vector of the sixth adder circuit with the threshold vector.
